(19) United States
(12) Patent Application Publication
(10) Pub. No.: US 2026/0016984 A1
(43) Pub. Date: Jan. 15, 2026

(54) QUAD-CHANNEL MEMORY MODULE WITH INTERLEAVED DATA COMMUNICATION

(71) Applicant: Rambus Inc., San Jose, CA (US)

(72) Inventors: Steven C. WOO, Saratoga, CA (US); Robert E. PALMER, Chapel Hill, NC (US); Evan Lawrence ERICKSON, Chapel Hill, NC (US)

(21) Appl. No.: 19/256,616

(22) Filed: Jul. 1, 2025

Related U.S. Application Data
(60) Provisional application No. 63/669,490, filed on Jul. 10, 2024.
(60) Provisional application No. 63/674,117, filed on Jul. 22, 2024.
(60) Provisional application No. 63/724,741, filed on Nov. 25, 2024.

(51) Int. Cl. G06F 3/06

(52) U.S. Cl. CPC G06F 3/0656; G06F 3/0604; G06F 3/0659; G06F 3/0673

(57) ABSTRACT

A four-channel by two ranks-per-channel memory module includes four independent memory channels and dual-channel memory devices. The channels of the dual-channel memory module devices may be accessed independently. Thus, the four channels for accessing the memory module may each concurrently access, via a one of the two channels of the memory devices, a respective first rank and a second rank. Data buffer devices on the memory module communicate data between the two ranks and the channels. The data buffer devices multiplex/demultiplex (a.k.a., interleave/deinterleave) communication between the channels and the ranks so that the channels operate at a greater bandwidth (e.g., quad-data rate—QDR) than the memory devices (e.g., double-data rate—DDR). The data buffer devices also retime and/or redistribute data strobe signals communicated between the memory devices and the channels.

### BRIEF DESCRIPTION OF THE DRAWINGS

FIGS. 1A-1B are block diagrams illustrating a memory system.

FIGS. 2A-2D are diagrams illustrating a memory module.

FIG. 3 is a diagram illustrating control circuitry and data couplings of an example data buffer.

FIG. 4 is a block diagram illustrating example data buffer functionality for a channel.

FIG. 5A-5B are timing diagrams illustrating an example interleaving of data for multiple ranks per channel.

FIG. 6 is a timing diagram illustrating data buffer read operations.

FIG. 7 is a timing diagram illustrating data buffer read operations of a first channel interface of pair of ranks and data buffer write operations to a second channel interface of the pair of ranks.

FIG. 8 is a diagram illustrating a codeword configuration.

FIG. 9 is a flowchart illustrating a method of operating a data buffer device.

FIG. 10 is a flowchart illustrating a method of communicating data with multiple ranks of memory devices.

FIG. 11 is a flowchart illustrating a method of communicating data between a channel and multiple ranks of memory devices.

FIG. 12 is a block diagram of a processing system.

### DETAILED DESCRIPTION OF THE EMBODIMENTS

A four-channel by two ranks-per-channel memory module includes four independent memory channels and dual-channel memory devices. The channels of the dual-channel memory module devices may be accessed independently. Thus, the four channels for accessing the memory module may each concurrently access, via one of the two channels of the memory devices, a respective first rank and a second rank. Data buffer devices on the memory module communicate data between the two ranks and the channels. The data buffer devices multiplex/demultiplex (a.k.a., interleave/deinterleave) communication between the channels and the ranks so that the channels operate at a greater bandwidth (e.g., quad-data rate—QDR) than the memory devices (e.g., double-data rate—DDR). The data buffer devices also retime and/or redistribute data strobe signals communicated between the memory devices and the channels.

The descriptions and embodiments disclosed herein are made primarily with references to DRAM devices and DRAM memory arrays. This, however, should be understood to be a first example due at least to the widespread adoption of DRAM technology. It should be understood that other memory technologies may also benefit from the methods and/or apparatus described herein. These memory technologies include, but are not limited to static random access memory (SRAM), non-volatile memory (such as flash), conductive bridging random access memory (CBRAM—a.k.a., programmable metallization cell—PMC), resistive random access memory (a.k.a., RRAM or ReRAM), magnetoresistive random-access memory (MRAM), Spin-Torque Transfer (STT-MRAM), phase change memory (PCM), and the like, and/or combinations thereof. Accordingly, it should be understood that in the disclosures and/or descriptions given herein, these aforementioned technologies may be substituted for, included with, and/or encompassed within, the references to DRAM, DRAM devices, and/or DRAM arrays made herein.

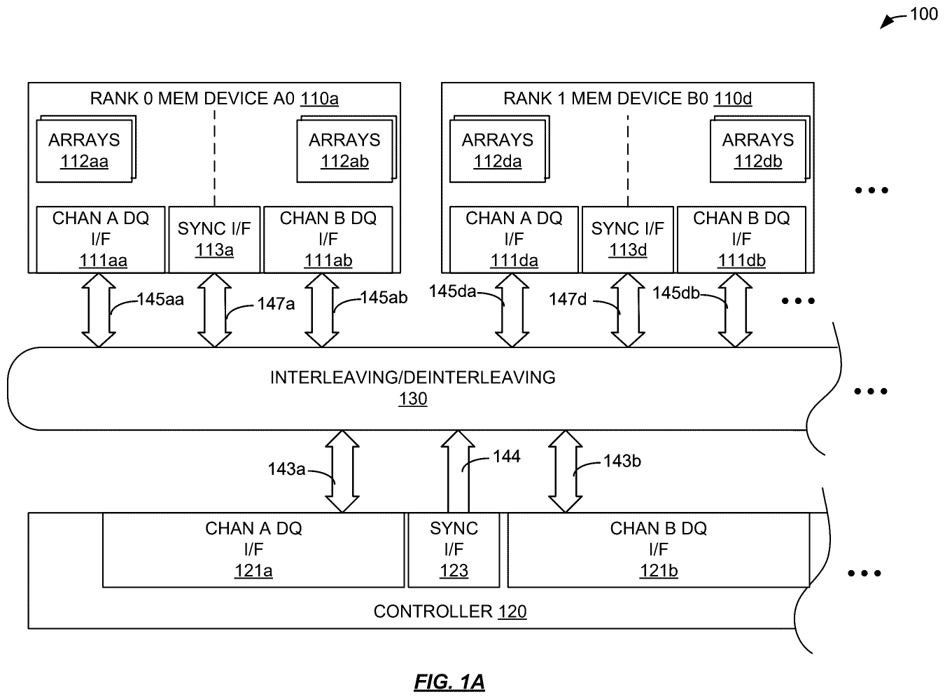

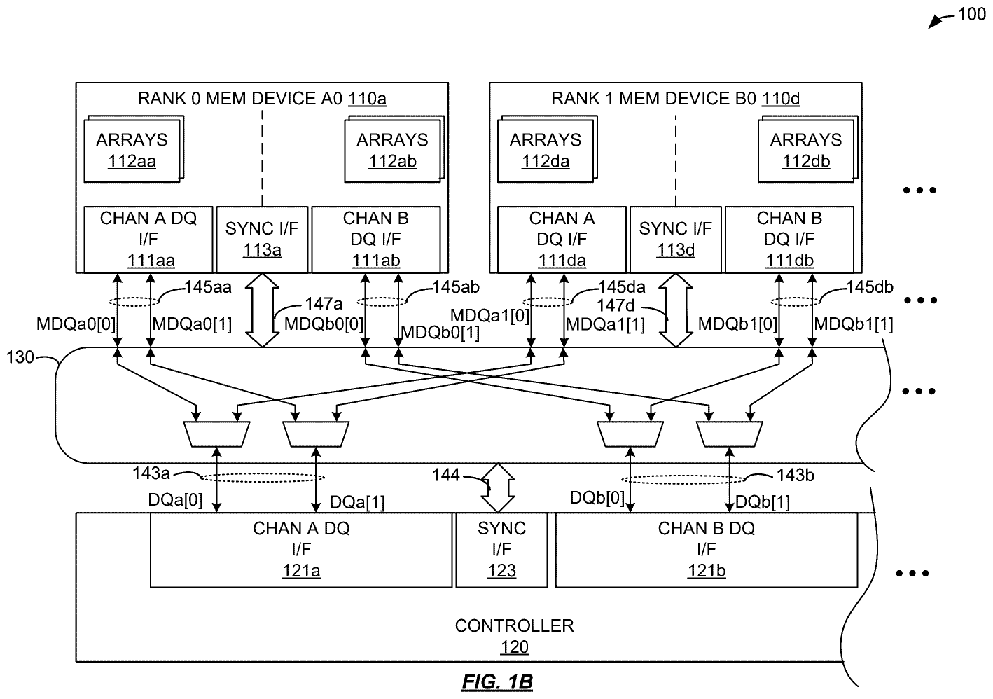

FIGS. 1A-1B are block diagrams illustrating a memory system. In FIGS. 1A-1B, memory system 100 comprises rank 0 memory device 110a, rank 1 memory device 110d, controller 120, and interleaving/deinterleaving 130 Interleaving/deinterleaving 130 may include, or be, one or more data buffer devices. Memory device 110a includes channel A data (DQ) interface 111aa, channel B DQ interface 111ab, and synchronization signal (e.g., data strobes, write clocks) interface 113a. Memory device 110d includes channel A DQ interface 111da, channel B DQ interface 111 db, and synchronization signal interface 113d. Memory device 110a also includes memory arrays 112aa-112ab. Memory device 110d also includes memory arrays 112da-112db. Controller 120 includes channel A DQ interface 121a, channel B DQ interface 121b, and synchronization signal interface 123.

Controller 120, memory device 110a, memory device 110d, and interleaving/deinterleaving 130 may be one or more integrated circuit type devices, such as are commonly referred to as “chips”. A memory controller, such as controller 120, manages the flow of data going to and from memory devices and/or memory modules. Memory device 110a, and memory device 110d may be standalone devices, or may be a component of a memory module such as a DIMM module used in servers. In an embodiment, memory device 110a and memory device 110d may be devices that adhere to, or are compatible with, a dynamic random access memory (DRAM) specification. In an embodiment, memory device 110a and memory device 110d may be, or comprise, a device that is or includes other memory device technologies and/or specifications. A memory controller can be a separate, standalone chip, or integrated into another chip. For example, a memory controller 120 may be included on a single die with a microprocessor, included as a chip co-packaged with one or more microprocessor chips, included as part of a more complex integrated circuit system such as a block of a system on a chip (SOC), or be remotely coupled to one or more microprocessors via a fabric interconnect or other type of interconnect. In addition, memory controller functionality may be disposed on a separate Input/Output (I/O) die along with the transmitter/receiver circuits that interface to the memory device. Such an I/O die may include other types of I/O interfaces, as well as one or more chiplet interfaces that communicate with one or more respective CPU chiplet dies. The I/O die and CPU chiplet dies may be co-packaged together and coupled to one-another via a silicon interposer.

In an embodiment, memory device 110a and memory device 110d are disposed on a substrate having local interfaces (not shown in FIG. 1), controller side synchronization signals 144, memory device side synchronization signals 147a, memory device side synchronization signals 147d, memory device side DQ signals 145aa-145ab, memory device side DQ signals 145da-145db, controller side channel A DQ signals 143a, and controller side channel B DQ signals 143d, interconnected to form a memory module. Controller side channel A DQ signals 143a and controller side channel B DQ signals 143b may each comprise time-multiplexed data signals. Channel A DQ signals 143a operatively couple channel A DQ interface 121a with interleaving/deinterleaving 130. Channel B DQ signals 143b operatively couple channel B DQ interface 121b with interleaving/deinterleaving 130. Data signals 145aa operatively couple interleaving/deinterleaving 130 with channel A DQ interface 111aa of memory device 110a. Data signals 145ab operatively couple interleaving/deinterleaving 130 with channel B DQ interface 111ab of memory device 110a. Data signals 145da operatively couple interleaving/deinterleaving 130 with channel A DQ interface 111da of memory device 110d. Data signals 145db operatively couple interleaving/deinterleaving 130 with channel B DQ interface 111 db of memory device 110d.

In an embodiment, controller 120 is operatively coupled with channel A DQ interface 111aa of memory device 110a via channel A DQ interface 121a, data signals 143a, interleaving/deinterleaving 130, and data signals 145aa. Controller 120 is operatively coupled to channel B DQ interface 111ab of memory device 110a via channel B DQ interface 121b, data signals 143b, interleaving/deinterleaving 130, and data signals 145ab. Controller 120 is operatively coupled to synchronization signal interface (e.g., clock signal, data strobe-DQS, write clock—WCK) 113a of memory device 110a via synchronization signal interface 123, synchronization signals 144, interleaving/deinterleaving 130, and synchronization signals 147a.

In an embodiment, controller 120 is operatively coupled with channel A DQ interface 111da of memory device 110d via channel A DQ interface 121a, data signals 143a, interleaving/deinterleaving 130, and data signals 145da. Controller 120 is operatively coupled to channel B DQ interface 111db of memory device 110d via channel B DQ interface 121b, data signals 143b, interleaving/deinterleaving 130, and data signals 145db. Controller 120 is operatively coupled to synchronization signal interface 113d of memory device 110d via synchronization signal interface 123, synchronization signals 144, interleaving/deinterleaving 130, and synchronization signals 147d. In an embodiment, interleaving/deinterleaving 130 operates such that data signals 145aa-145ab and data signals 145da-145db communicate at a first data rate (e.g., double data rate—DDR) and data signals 143a and data signals 143b communicate at a second data rate that is a positive integer multiple of the first data rate (e.g., 2× of DDR, a.k.a., quad data rate—QDR).

In an embodiment, each of channels A-B of memory device 110a operate command, address, and data transfer functions of respective channels A-B and channel DQ interfaces 111aa-111ab independently of the other channel A-B and channel DQ interfaces 111aa-111ab. Each of channels A-B of memory device 110d operate command, address, and data transfer functions of respective channels A-B and channel DQ interfaces 111da-111db independently of the other channel A-B and channel DQ interfaces 111da-111db. Each of channels A-B of memory device 110a access non-overlapping sets of memory arrays 112aa-112ab. Each of channels A-B of memory device 110d access non-overlapping sets of memory arrays 112da-112db.

In an embodiment, channels A-B of memory device 110a may share (e.g., time-multiplex and/or intersperse individually addressed, by channel, commands/address) command/address signals with each other. Thus, channel A DQ interface 111aa is operated, with the exception of the time multiplexing (e.g., interleaving, alternating, and/or interspersing) of commands and addresses communicated via the shared CA signals, to access memory arrays 112aa independent of the accesses of memory arrays 112ab via channel B DQ interface 111ab. Likewise, in this embodiment, channel B DQ interface 11ab is operated, with the exception of the time multiplexing (e.g., interleaving, alternating, and/or interspersing) of commands communicated via the shared CA signals, to access memory arrays 112ab independent of the accesses of memory arrays 112aa via channel A DQ interface 111aa. In an embodiment, commands communicated via the shared CA signals may access both memory arrays 112aa and memory array 112ab in lockstep and are therefore not independent of the accesses to the other memory array 112aa-112ab.

In an embodiment, each of channel DQ interfaces 111aa-111ab, channel DQ interfaces 111da-111db, and channel DQ interfaces 121a-121b include two (2) bidirectional data (DQ) signals. In an embodiment, synchronization signal interface 123 includes at least one data strobe (DQS) signal for each of channel DQ interfaces 121a-121b. In an embodiment, synchronization signal interface 113a includes at least one DQS signal for each of channel DQ interface 111aa-111ab and synchronization signal interface 113d includes at least one DQS signal for each of channel DQ interface 111da-111db. Each of the channel DQ interfaces 111aa-111ab, and channel DQ interfaces 111da-111db include or are associated with respective command address (CA) bus interfaces (not shown in FIGS. 1A-1B) that operate independently of the other CA bus interfaces to access non-overlapping sets of memory arrays 112aa-112bb and memory arrays 112da-112db in their respective memory device 110a and memory device 110d. Similarly, each of and the channel DQ interfaces 121a-121b include or are associated with respective command address (CA) bus interfaces (not shown in FIGS. 1A-1B) that operate independently of the other CA bus interfaces of controller 120 to access memory device 110a and memory device 110b.

In an embodiment, memory device 110a and memory device 110d are representative of a larger number of memory devices on a memory module. For example, memory device 110a may be representative of ten (10) memory devices that comprise a first rank on a memory module. Likewise, for example, memory device 110d may be representative of ten (10) memory devices that comprise a second rank on the memory module. In this example, therefore, channel interfaces 121a-121b of controller 120 form two (A and B) twenty (20) data bit channels (along with accompanying CA signals). Each twenty data bit channel may communicate sixteen (16) data bits along with four (4) bits of reliability, availability, serviceability (RAS) information (e.g., Reed-Solomon—RS—coding or error correct and detect EDC coding).

Controller 120 may also include additional channels coupled to additional memory devices on the same module. For example, controller 120 may include two additional channel interfaces (e.g., channel C and channel D interfaces) that couple to another ten (10) memory devices thereby forming an additional two (C and D) twenty (20) data bit channels (along with accompanying CA signals). Similar to channels A-B, each additional twenty data bit channel may communicate sixteen (16) data bits along with four (4) bits of RAS information.

FIG. 1B illustrates memory system 100 with an example configuration having two data signals per data signals 145aa-145ab, data signals 145da-145db, data signals 143a, and data signals 143b. It should be understood, however, this is merely one example. Other numbers of bits per channel DQ interfaces 111aa-111ab, channel DQ interfaces 111da-111db, and channel DQ interfaces 121a-121b are contemplated (e.g., 3 signals, 4 signals, 6 signals, etc.).

In FIG. 1B, in order to more clearly show the functioning of interleaving/deinterleaving 130, data signals 145aa are illustrated as example data signals MDQa0[0:1]. Data signals 145ab are illustrated as example data signals MDQb0[0:1]. Data signals 145da are illustrated as example data signals MDQa1[0:1]. Data signals 145db are illustrated as example data signals MDQb1[0:1]. Data signals 143a are illustrated as example data signals DQa[0:1]. Finally, data signals 143b are illustrated as example DQb[0:1].

Thus, it should be evident from FIGS. 1A-1B that a naming convention for signals discussed herein generally follows a pattern. That pattern may be illustrated as: signal name (e.g., “MDQ”), followed by channel, if applicable, (e.g., “a” or “b”), followed by rank, if applicable (e.g., “0” or “1”), followed by signal association identifier(s), if applicable (e.g., “01” if associated with signals/bits 0 and 1, “23” if associated with signals/bits 2 and 3, etc.), and finally, if applicable, (bit/signal number in brackets—e.g., [0], [1], [2], etc.). Thus, for example, the signal name MDQa1[1] indicates the signal is, from controller 120's perspective, part of rank 1 on channel A. Similarly, for example, the signal name DQSa indicates the signal is, from the controller's perspective, associated with channel A. Finally, for example, the signal name MDQSb123 indicates the signal is associated with bits/signals 2 and 3, of rank 1, on channel B.

Interleaving/deinterleaving 130 is configured to interleave/deinterleave MDQa0[0] (from/to data interface 111aa of rank 0 memory device A0 110a) with MDQa1[0] (from/to data interface 111da of rank 1 memory device B0 110d) and communicate an interleaved MDQa0[0] and MDQa1[0] with channel A DQ interface 121a via DQa[0]. Interleaving/deinterleaving 130 is configured to interleave/deinterleave MDQa0[1] (from/to data interface 111aa of rank 0 memory device A0 110a) with MDQa1[1] (from/to data interface 111da of rank 1 memory device B0 110d) and communicate an interleaved MDQa0[1] and MDQa1[1] with channel A DQ interface 121a via DQa[1]. Interleaving/deinterleaving 130 is configured to interleave/deinterleave MDQb0[0] (from/to data interface 111ab of rank 0 memory device A0 110a) with MDQb1[0] (from/to data interface 111db of rank 1 memory device B0 110d) and communicate an interleaved MDQb0[0] and MDQb1[0] with channel B DQ interface 121b via DQb[0]. Interleaving/deinterleaving 130 is configured to interleave/deinterleave MDQb0[1] (from/to data interface 111ab of rank 0 memory device A0 110a) with MDQb1[1] (from/to data interface 111db of rank 1 memory device B0 110d) and communicate an interleaved MDQb0[1] and MDQb1[1] with channel B DQ interface 121b via DQb[1].

Thus, it should be understood that the configuration illustrated in FIG. 1B interleaves/deinterleaves data signals (e.g., MDQa0[0] and MDQa1[0]) to/from (i.e., between, or among) memory devices (e.g., rank 0 memory device 110a and rank 1 memory device 110d) of different ranks (e.g., rank 0 and rank 1) for communication with controller 120 (e.g., via DQa[0] and channel A DQ interface 121a). It should also be understood that, in some embodiments, the data to/from the various data channels of the memory device 110a and memory device 110d are communicated at one-half the data rate (e.g., DDR) that data is communicated to/from controller 120 (e.g., QDR). These different data rates may be correspondingly reflected in the timings (e.g., frequency) of synchronization signals 147a, synchronization signals 147d, and synchronization signals 144.

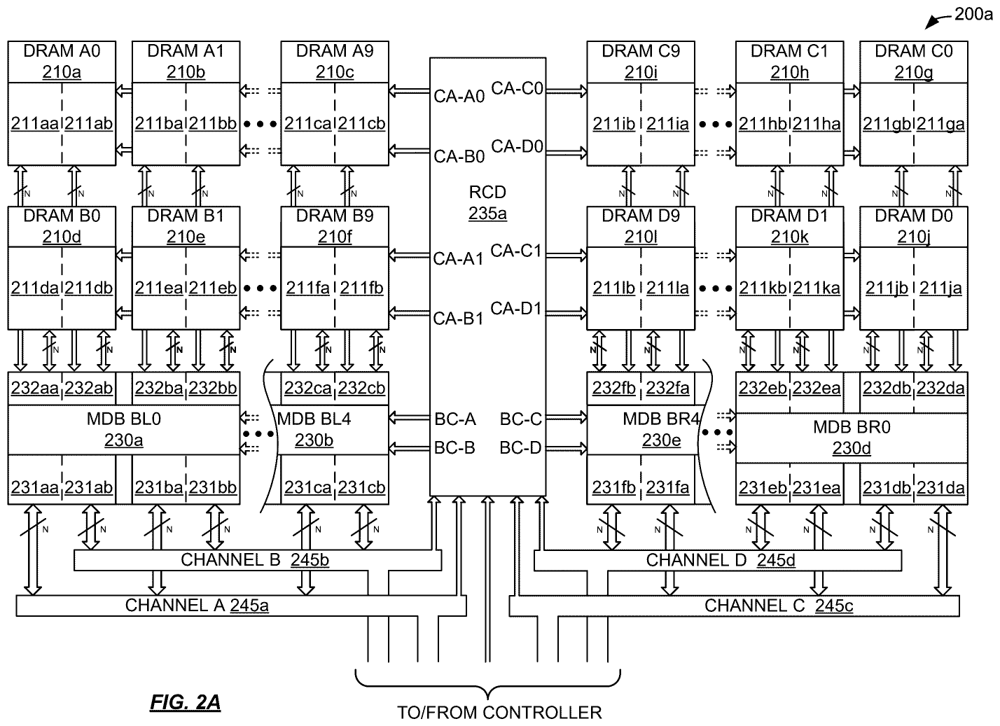

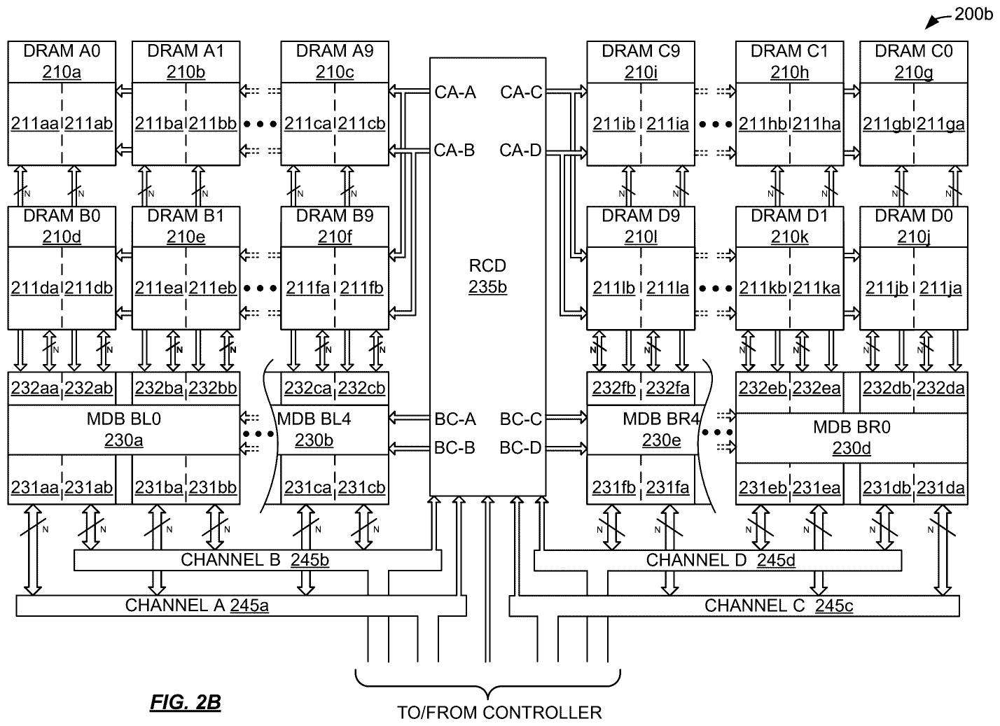

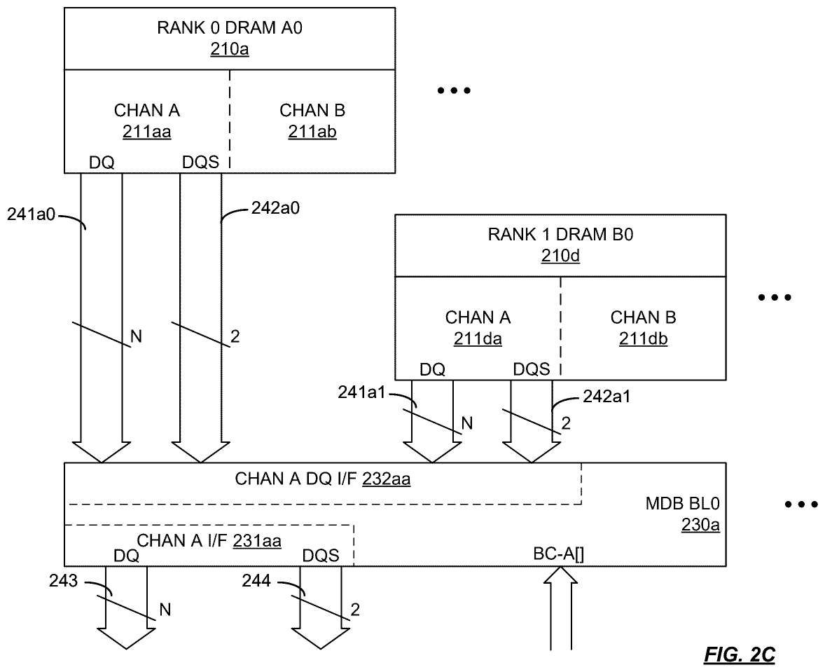

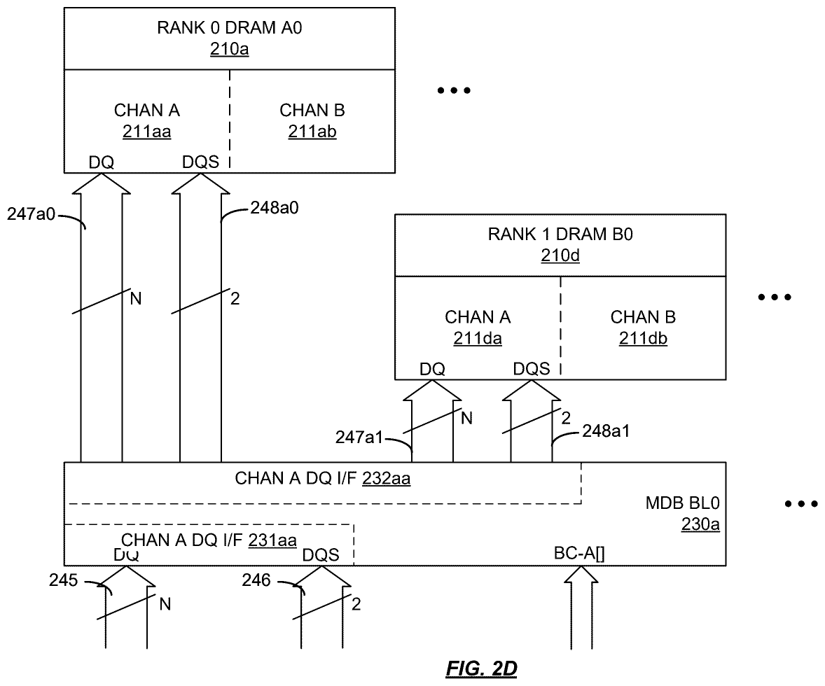

FIGS. 2A-2D are diagrams illustrating a memory module. In FIG. 2A, module 200a comprises left side rank 0 dual-channel DRAM devices 210a-210c (representing ten DRAM devices A0-A9), left side rank 1 dual-channel DRAM devices 210d-210f (representing ten DRAM devices B0-B9), right side rank 0 dual-channel DRAM devices 210g-210i (representing ten DRAM devices C0-C9), right side rank 1 dual-channel DRAM devices 210j-2101 (representing ten DRAM devices D0-D9), left side dual-channel buffer devices 230a-230b (representing five buffer devices BL0-BL4), right side dual-channel buffer devices 230d-230e (representing five buffer devices BR0-BR4), registering clock driver (RCD) 235a, channel A interface 245a, channel B interface 245b, channel C interface 245c, and channel D interface 245d. In FIG. 2B, module 200b comprises left side rank 0 dual-channel DRAM devices 210a-210c (representing ten DRAM devices A0-A9), left side rank 1 dual-channel DRAM devices 210d-210f (representing ten DRAM devices B0-B9), right side rank 0 dual-channel DRAM devices 210g-210i (representing ten DRAM devices C0-C9), right side rank 1 dual-channel DRAM devices 210j-2101 (representing ten DRAM devices D0-D9), left side dual-channel buffer devices 230a-230b (representing five buffer devices BL0-BL4), right side dual-channel buffer devices 230d-230e (representing five buffer devices BR0-BR4), registering clock driver (RCD) 235b, channel A interface 245a, channel B interface 245b, channel C interface 245c, and channel D interface 245d. RCD 235b receives certain signals (e.g., clock, chip select) that are common to the channel A-D interfaces 245a-245d.

Each dual-channel DRAM device 210a-2101 includes two non-overlapping set of memory arrays that are respectively accessed via two channel interfaces 211aa-211lb that operate independently of each other. In other words, each DRAM device 210a-2101 device operates the command, address, and data transfer functions of their respective channel interfaces 211aa-2111b independently of the other channel interfaces 211aa-211lb on the same DRAM device 210a-2101. Thus, for example, channel A interface 211aa of DRAM A0 210a accesses a first set of memory arrays in DRAM A0 210a and channel B interface 211ab of DRAM A0 210a accesses a second set of memory arrays in DRAM A0 210a, where the first set of memory arrays and the second set of memory array do not have any common memory array (i.e., are non-overlapping sets).

In FIG. 2A, at least the CA signals of channel A interface 245a are operatively coupled to RCD 235a. RCD 235a operatively couples, via command/address signals CA-A0, the rank 0 CA signals of channel A interface 245a to the channel A interfaces 211aa-211ca of the left side rank 0 DRAM devices 210a-210c. RCD 235a operatively couples, via command/address signals CA-A1, the rank 1 CA signals of channel A interface 245a to the channel A interfaces 211da-211fa of the left side rank 1 DRAM devices 210d-210f. Similarly, at least the CA signals of channel B interface 245b are operatively coupled to RCD 235a. RCD 235a operatively couples, via command/address signals CA-B0, the rank 0 CA signals of channel B interface 245b to the channel B interfaces 211ab-211cb of the left side rank 0 DRAM devices 210a-210c. RCD 235a operatively couples, via command/address signals CA-B1, the rank 1 CA signals of channel B interface 245b to the channel B interfaces 211db-211fb of the left side rank 1 DRAM devices 210d-210f.

At least the CA signals of channel C interface 245c are operatively coupled to RCD 235a. RCD 235a operatively, via command/address signals CA-C0, couples the rank 0 CA signals of channel C interface 245c to the channel A interfaces 211ga-211ia of the right side rank 0 DRAM devices 210g-210i. RCD 235a operatively, via command/address signals CA-C1, couples the rank 1 CA signals of channel C interface 245c to the channel A interfaces 211ja-211la of the right side rank 1 DRAM devices 210j-2101. Similarly, at least the CA signals of channel D interface 245d are operatively coupled to RCD 235a. RCD 235a operatively couples, via command/address signals CA-D0, the rank 0 CA signals of channel D interface 245d to the channel B interfaces 211gb-211ib of the right side rank 0 DRAM devices 210g-210i. RCD 235a operatively couples, via command/address signals CA-D1, the rank 1 CA signals of channel D interface 245d to the channel B interfaces 211jb-211lb of the right side rank 1 DRAM devices 210j-2101.

In FIG. 2B, at least the CA signals of channel A interface 245a are operatively coupled to RCD 235b. RCD 235b operatively couples, via command/address signals CA-A, the CA signals of channel A interface 245a to the channel A interfaces 211aa-211ca of the left side rank 0 DRAM devices 210a-210c and to the channel A interfaces 211da-211fa of the left side rank 1 DRAM devices 210d-210f. Similarly, at least the CA signals of channel B interface 245b are operatively coupled to RCD 235b. RCD 235b operatively couples, via command/address signals CA-B, the CA signals of channel B interface 245b to the channel B interfaces 211ab-211cb of the left side rank 0 DRAM devices 210a-210c and to the channel B interfaces 211db-211fb of the left side rank 1 DRAM devices 210d-210f.

At least the CA signals of channel C interface 245c are operatively coupled to RCD 235b. RCD 235b operatively, via command/address signals CA-C, couples the CA signals of channel C interface 245c to the channel A interfaces 211ga-211ia of the right side rank 0 DRAM devices 210g-210i and to the channel A interfaces 211ja-211la of the right side rank 1 DRAM devices 210j-2101. Similarly, at least the CA signals of channel D interface 245d are operatively coupled to RCD 235b. RCD 235b operatively couples, via command/address signals CA-D, the CA signals of channel D interface 245d to the channel B interfaces 211gb-211ib of the right side rank 0 DRAM devices 210g-210i and to the channel B interfaces 211jb-211lb of the right side rank 1 DRAM devices 210j-2101.

RCD 235a and RCD 235b operatively couple channel A buffer command signals BC-A to left side dual-channel buffer devices 230a-230b. RCD 235a and RCD 235b operatively couple channel B buffer command signals BC-B to left side dual-channel buffer devices 230a-230b. RCD 235a and RCD 235b operatively couple channel C buffer command signals BC-C to right side dual-channel buffer devices 230d-230e. RCD 235a and RCD 235b operatively couple channel D buffer command signals BC-D to right side dual-channel buffer devices 230d-230e.

The channel A interface 211aa of rank 0 DRAM device 210a is operatively coupled to communicate N bits of data in parallel per unit interval with the device side channel A DQ interface 232aa of data buffer device 230a. In an embodiment, N=2. The channel A interface 211da of rank 1 DRAM device 210d is operatively coupled to communicate N bits of data in parallel per unit interval with the device side channel A DQ interface 232aa of data buffer device 230a.

The channel B interface 211ab of rank 0 DRAM device 210a is operatively coupled to communicate N bits of data in parallel per unit interval with the device side channel B DQ interface 232ab of data buffer device 230a. The channel B interface 211db of rank 1 DRAM device 210d is operatively coupled to communicate N bits of data in parallel per unit interval with the device side channel B DQ interface 232ab of data buffer device 230a. The channel A interface 211ba of rank 0 DRAM device 210b is operatively coupled to communicate N bits of data in parallel per unit interval with the device side channel A DQ interface 232ba of data buffer device 230a; the channel A interface 211ea of rank 1 DRAM device 210e is operatively coupled to communicate N bits of data in parallel per unit interval with the device side channel A DQ interface 232ba of data buffer device 230a; the channel B interface 211bb of rank 0 DRAM device 210b is operatively coupled to communicate N bits of data in parallel per unit interval with the device side channel B DQ interface 232bb of data buffer device 230a; the channel B interface 211eb of rank 1 DRAM device 210e is operatively coupled to communicate N bits of data in parallel per unit interval with the device side channel B DQ interface 232bb of data buffer device 230a, and so on with a like pattern of connection for all of the DRAM devices 210a-210l and data buffer devices 230a-230e on module 200a and module 200b (which, for the sake of brevity will not be detailed herein).

Controller side channel A DQ interface 231aa is operatively coupled to channel A interface 245a. Controller side channel A DQ interface 231aa communicates N bits in parallel per one-half unit interval of device side DQ interfaces 232aa-232fb with channel A interface 245a for a total of N×2 bits being communicated per unit interval of device side DQ interfaces 232aa-232fb. The N×2 bits comprise N bits communicated with rank 0 DRAM device 210a and N bits communicated with rank 1 DRAM device 210d. Similarly, controller side channel B interface 231ab is operatively coupled to channel B interface 245b. Likewise, the controller side channel A interfaces 231ba-231ca of data buffer devices 230a-230b are operatively coupled to channel A interface 245a; the controller side channel B interfaces 231bb-231cb of data buffer devices 230a-230b are operatively coupled to channel B interface 245b; the controller side channel A interfaces 231da-231fa of data buffer devices 230d-230e are operatively coupled to channel C interface 245c; and, the controller side channel D interfaces 231db-231fb of data buffer devices 230d-230e are operatively coupled to channel D interface 245d.

FIG. 2C illustrates a read operation on channel A of module 200a and/or module 200b using rank 0 DRAM device 210a, rank 1 DRAM device 210d, and data buffer device 230a as a representative example. In FIG. 2C, channel A interface 211aa of rank 0 DRAM device 210a provides N bits of data signals 241a0 and a differential data strobe (DQS) signal 242a0 to device side channel A DQ interface 232aa of data buffer device 230a. Channel A DQ interface 211da of rank 1 DRAM device 210d provides N bits of data signals 241a1 and a differential data strobe (DQS) signal 242a1 to device side channel A DQ interface 232aa of data buffer device 230a. In response, data buffer device 230a realigns (re-times) one or more of data signals 241a0-241a1 to be output by controller side channel A DQ interface 231aa as N number of data signals 243 carrying interleaved (time multiplexed) data (i.e., interleaved between data signals 241a0 and data signals 241a1). The N number of data signals 243 are output in relation to a data strobe signal 244 also output by controller side channel A DQ interface 231aa. It should be understood that since the timing of data signals 243 is in relation to the timing of data strobe signal 244, data buffer device 230a may equivalently be seen as realigning (re-timing) one or more of data strobe signal 242a0 and/or data strobe signal 242a1 in relation to received data signals 241a0 and data signals 241a1 before being output by controller side channel A DQ interface 231aa as N number of interleaved (e.g., twice the data rate of the received data signals 241a0 and data signals 241a1) data signals 243 in relation to a data strobe signal 244. It should also be understood that re-timing the data signals 243 being output by data buffer device 230a in relation to a single differential data strobe signal 244 rather than at least two differential data strobe signals 242a0-242a1 reduces the number of data strobes being sent by controller side channel interfaces 231aa-231fb of data buffer devices 230a-230e to a controller (e.g., controller 120). Furthermore, since module 200a and/or module 200b may have one or more unequal signal trace lengths between channel interfaces data buffer device 230a-230e and the respective DRAM devices 210a-2101 to which they are coupled, data strobe signals between the interfaces of data buffer device 230a-230e and the respective DRAM devices 210a-2101 may have different relative timing skews to one or more other data strobe signals between the interfaces of data buffer device 230a-230e and the respective DRAM devices 210a-2101.

FIG. 2D illustrates a write operation on channel A of module 200 and/or module 200b using rank 0 DRAM device 210a, rank 1 DRAM device 210d, and data buffer device 230a as a representative example. In FIG. 2D, controller side channel A DQ interface 231aa of data buffer device 230a receives, from a controller (e.g., controller 120), N bits of data signals 245 carrying interleaved (time multiplexed) data (i.e., interleaved between data destined for rank 0 DRAM device 210a and data destined for rank 1 DRAM device 210d data signals 247a0 and data signals 247a1) and a differential data strobe (DQS) signal 246. In response, data buffer device 230a realigns (re-times) data signals 247a0 in relation to a data strobe signal 248a0 output by device side channel A DQ interface 232aa. Similarly, data buffer device 230a realigns (re-times) data signals 247a1 in relation to a data strobe signal 248a1 output by device side channel A DQ interface 232aa. Channel A DQ interface 232aa of data buffer device 230a provides N bits of data signals 247a0 and a differential data strobe (DQS) signal 248a0 to channel A interface 211aa of DRAM device 210a. Channel A DQ interface 232aa of data buffer device 230a provides N bits of data signals 247a1 and a differential data strobe (DQS) signal 248a1 to channel A interface 211da of rank 1 DRAM device 210d. It should be understood that since the timing of data signals 247a0-247a1 is in relation to the timing of data strobe signals 248a0-248a1, data buffer device 230a may equivalently be seen as realigning (re-timing) data strobe signal 246 in relation to received data signals 245 before being output by device side channel A DQ interface 232aa as two sets of N number of data signals 247a0-247a1 in relation to respective data strobe signals 2480a-248a1. It should also be understood that re-timing the data signals 247a0-247a1 being output by data buffer device 230a in relation to two data strobe signals 248a0-248a1 reduces the number of data strobes being sent by the controller to data buffer devices 230a-230e.

In an embodiment, the functions and/or circuitry of data buffer devices 230a-230e may be included in RCD 235. In such an embodiment, the data strobes communicated with module 200a and/or module 200b may be as low as one data strobe signal per channel interface 245a-245d.

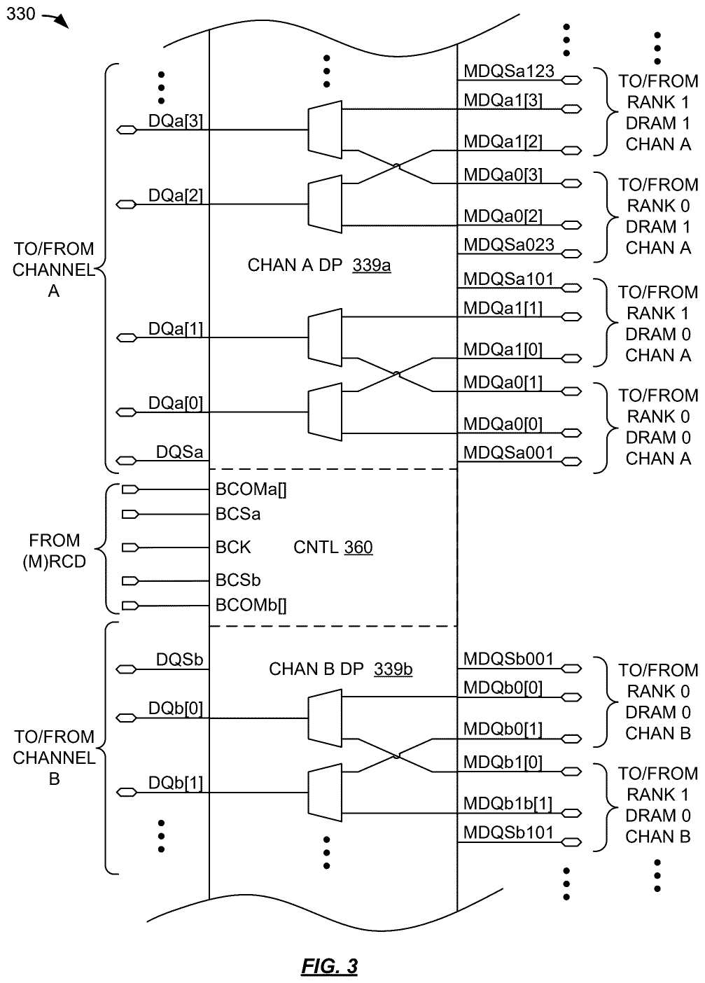

FIG. 3 is a diagram illustrating control circuitry and data couplings of an example data buffer. In FIG. 3, multiplexing data buffer (MDB) 330 comprises channel A datapath circuitry 339a, channel B datapath circuitry 339b, and control circuitry 360. Control circuitry 360 is to be operatively coupled with a registering clock driver (RCD—e.g., RCD 235) or multiplexing registering clock driver (MRCD). Control circuitry 360 is to be operatively coupled with an (M)RCD via a channel A buffer command bus BCOMa[ ], a channel A buffer command strobe signal BCSa, a channel B buffer command bus BCOMb[ ], a channel B buffer command strobe signal BCSb, and a buffer clock signal(s).

In FIG. 3, channel A datapath circuitry 339a includes connections/ports/pins for signals for communication with a memory channel (e.g., channel A). The signals to/from channel A that are to operatively couple with channel A datapath circuitry 339a include a data strobe signal DQSa, and data (DQ) signals DQa[0:3]. Channel B datapath circuitry 339b includes connections/ports/pins for signals for communication with a memory channel (e.g., channel B). The signals to/from channel B that are to operatively couple with channel B datapath circuitry 339b include a data strobe signal DQSb, and data (DQ) signals DQb[0:1] (and not illustrated in FIG. 3 for the sake of brevity, data signals DQb[2:3]).

Channel A datapath circuitry 339a and channel B datapath circuitry 339b each also include connections/ports/pins for signals for communication with at least four dual-channel DRAMs organized into two ranks: rank 0 DRAM 0 (e.g., DRAM device 210a), rank 0 DRAM 1 (e.g., DRAM device 210b), rank 1 DRAM 0 (e.g., DRAM device 210d), and rank 1 DRAM 1 (e.g., DRAM device 210e). Additional connections/ports/pins and circuitry for additional DRAM devices in rank 0 and rank 1 are contemplated. However, for the sake of brevity, they are not illustrated or discussed in relation to FIG. 3.

The signals to/from channel A interface of rank 0 DRAM 0 that are to operatively couple with channel A datapath circuitry 339a include data strobe signal MDQSa001 (i.e., data strobe for rank 0, bits 0 and 1), data signal MDQa0[0], and data signal MDQa0[1]. The signals to/from channel A interface of rank 1 DRAM 0 that are to operatively couple with channel A datapath circuitry 339a include data strobe signal MDQSa101 (i.e., data strobe for rank 1, bits 0 and 1), data signal MDQa1[0], and data signal MDQa1[1]. The signals to/from channel A interface of rank 0 DRAM 1 that are to operatively couple with channel A datapath circuitry 339a include data strobe signal MDQSa023 (i.e., data strobe for rank 0, bits 2 and 3), data signal MDQa0[2], and data signal MDQa0[3]. The signals to/from channel A interface rank 1 DRAM 1 that are to operatively couple with channel A datapath circuitry 339a include data strobe signal MDQSa123 (i.e., data strobe for rank 1, bits 2 and 3), data signal MDQa1[2], and data signal MDQa1[3].

The signals to/from channel B interface of rank 0 DRAM 0 that are to operatively couple with channel B datapath circuitry 339b include data strobe signal MDQSb001 (i.e., data strobe for rank 0, bits 0 and 1), data signal MDQb0[0], and data signal MDQb0[1]. The signals to/from channel B interface of rank 1 DRAM 0 that are to operatively couple with channel B datapath circuitry 339b include data strobe signal MDQSb101 (i.e., data strobe for rank 1, bits 0 and 1), data signal MDQb1[0], and data signal MDQb1[1]. The signals to/from channel B interface of rank 0 DRAM 1 that are to operatively couple with channel B datapath circuitry 339b include data strobe signal MDQSb023 (i.e., data strobe for rank 0, bits 2 and 3), data signal MDQb0[2], and data signal MDQb0[3] (not shown in FIG. 3). The signals to/from channel B interface rank 1 DRAM 1 that are to operatively couple with channel B datapath circuitry 339b include data strobe signal MDQSb123 (i.e., data strobe for rank 1, bits 2 and 3), data signal MDQb1[2], and data signal MDQb1[3] (not shown in FIG. 3).

Channel A datapath circuitry 339a operates under the control of control circuitry 360 and BCOMa[ ], in particular. Channel B datapath circuitry 339b operates under the control of control circuitry 360 and BCOMb[ ], in particular. Channel B datapath circuitry 339b functions in a similar manner to channel A datapath circuitry 339a. Thus, for the sake of brevity, only the functioning of channel A datapath circuitry 339a will be discussed herein and it should be understood that channel B datapath circuitry functions in a like manner with respect to the channel B interfaces of dual-channel DRAMs discussed herein.

Channel A datapath circuitry 339a functions to time-interleave (i.e., time-multiplex) data signal MDQa0[0] from rank 0 DRAM 0 (and synchronized by MDQsa001) with MDQa1[0] from rank 1 DRAM 0 (synchronized by MDQsa101) to produce DQa[0] (synchronized to DQSa). Channel A datapath circuitry 339a also functions to time-deinterleave (i.e., time-demultiplex) data signal DQa[0] (synchronized by DQSa) into MDQa0[0] to rank 0 DRAM 0 (synchronized to MDQsa001) and MDQa1[0] to rank 1 DRAM 0 (synchronized to MDQsa101). Channel A datapath circuitry 339a functions to time-interleave data signal MDQa0[1] from rank 0 DRAM 0 (and synchronized by MDQsa001) with MDQa1[1] from rank 1 DRAM 0 (synchronized by MDQsa101) to produce DQa[1] (synchronized to DQSa). Channel A datapath circuitry 339a also functions to time-deinterleave data signal DQa[1] (synchronized by DQSa) into MDQa0[1] to rank 0 DRAM 0 (synchronized to MDQsa001) and MDQa1[1] to rank 1 DRAM 0 (synchronized to MDQsa101).

Similarly, channel A datapath circuitry 339a functions to time-interleave data signal MDQa0[2] from rank 0 DRAM 1 (synchronized by MDQsa023) with MDQa1[2] from rank 1 DRAM 1 (synchronized by MDQsa123) to produce DQa[2] (synchronized to DQSa). Channel A datapath circuitry 339a also functions to time-deinterleave data signal DQa[2] (synchronized by DQSa) into MDQa0[2] to rank 0 DRAM 1 (synchronized to MDQsa023) and MDQa1[2] to rank 1 DRAM 1 (synchronized to MDQsa123). Channel A datapath circuitry 339a functions to time-interleave data signal MDQa0[3] from rank 0 DRAM 1 (synchronized by MDQsa023) with MDQa1[3] from rank 1 DRAM 1 (synchronized by MDQsa123) to produce DQa[3] (synchronized to DQSa). Channel A datapath circuitry 339a also functions to time-deinterleave data signal DQa[3] (synchronized by DQSa) into MDQa0[3] to rank 0 DRAM 1 (synchronized to MDQsa023) and MDQa1[3] to rank 1 DRAM 1 (synchronized to MDQsa123).

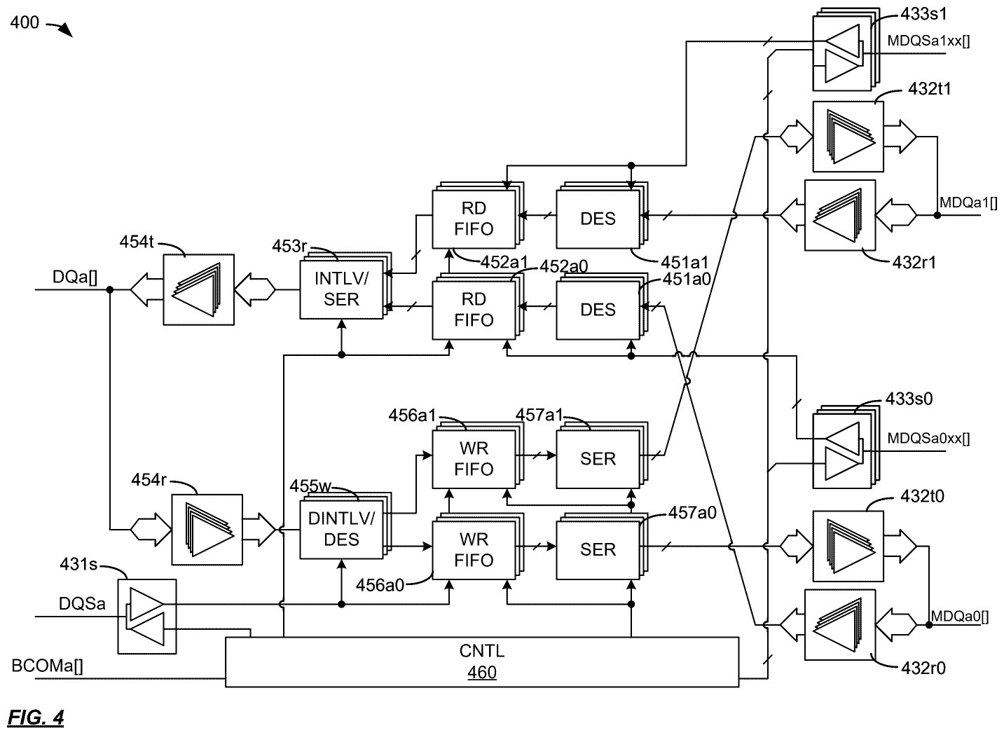

FIG. 4 is a block diagram illustrating example data buffer circuitry for a channel. The buffer circuitry illustrated in FIG. 4 may be, be a portion of, or comprise, examples of control circuitry 360 and channel A datapath circuitry 339a. In FIG. 4, buffer circuitry 400 comprises channel (host) side bidirectional data strobe interface 431s, memory device side rank 0 data signal receivers 432r0, memory device side rank 0 data signal transmitters 432t0, memory device side rank 1 data signal receivers 432r1, memory device side rank 1 data signal transmitters 432t1, memory device side bidirectional rank 0 data strobe signal interfaces 433s0, memory device side bidirectional rank 1 data strobe signal interfaces 433s1, rank 0 deserializers 451a0, rank 1 deserializers 451a1, rank 0 read data first-in first-out buffers (FIFOs) 452a0, rank 1 read data FIFOs 452a1, read data interleavers (a.k.a., serializers or time-multiplexers) 453r, channel side data transmitters 454t, channel side data receivers 454r, write data deinterleavers (a.k.a., deserializers or time-demultiplexers) 455w, rank 0 write data FIFOs 456a0, rank 1 write data FIFOs 456a1, rank 0 write data serializers 457a0, rank 1 write data serializers 457a1, and control circuitry 460.

Buffer command bus BCOMa[ ] is operatively coupled to control circuitry 460. In operation, buffer circuitry 400 operates under the control of control circuitry 460 based on commands received via BCOMa[ ]. Control circuitry is operatively coupled to channel side strobe interface 431s, read data interleavers 453r, rank 0 read data FIFOs 452a0, and rank 1 read data FIFOs 452a1. Control circuitry operatively coupled to channel side strobe interface 431s, read data interleavers 453r, rank 0 read data FIFOs 452a0, and rank 1 read data FIFOs 452a1 to provide at least one synchronization signal to synchronize transfers of read data. Control circuitry 460 is operatively coupled to rank 0 write data FIFOs 456a0, rank 1 write data FIFOs 456a1, rank 0 write data serializers 457a0, rank 1 write data serializers 457a1, rank 0 data strobe signal interfaces 433s0, and rank 1 data signal strobe interfaces 433s1. Control circuitry 460 is operatively coupled to rank 0 write data FIFOs 456a0, rank 1 write data FIFOs 456a1, rank 0 write data serializers 457a0, rank 1 write data serializers 457a1, rank 0 data strobe signal interfaces 433s0, and rank 1 data strobe signal interfaces 433s1 to provide at least one synchronization signal to synchronize transfers of write data.

Read data on data signals MDQa0[ ] from rank 0 dual-channel memory devices is received from rank 0 memory devices via rank 0 read data signal receivers 432r0 and synchronized by strobe signals received by data strobe signal interfaces 433s0. The rank 0 read data is coupled to deserializers 451a0 which further couples the read data to rank 0 read data FIFOs 452a0. Read data on data signals MDQa1[ ] from rank 1 dual-channel memory devices is received from rank 1 memory devices via rank 1 read data signal receivers 432r1 and synchronized by strobe signals received by data strobe signal interfaces 433s1. The rank 1 read data is coupled to deserializers 451a1 which further couples the read data to rank 1 read data FIFOs 452a1. Rank 0 read data and rank 1 read data are respectively output by data FIFOs 452a0-452a1 and provided to data interleavers 453r. Interleavers 453r time-interleave the rank 0 read data and the rank 1 read data and provide the time-interleaved data to data transmitters 454t which outputs the time-interleaved data on channel side data signals DQa[ ] synchronized by strobe signal DQSa output by data strobe interface 431s.

Time-interleaved write data for rank 0 memory devices and rank 1 memory devices is received from data signals DQa[ ] via channel side data receivers 454r synchronized by a strobe signal DQSa received via data strobe interface 431s. The time-interleaved write data is deinterleaved by deinterleavers 455w and rank 0 write data provided to rank 0 write data FIFOs 456a0 and rank 1 write data provided to rank 1 write data FIFOs 456a1. Rank 0 write data is output by write data FIFOs 456a0 and provided to write data serializers 457a0. Rank 1 write data is output by write data FIFOs 456a1 and provided to write data serializers 457a1. Rank 0 write data output by rank 0 write data serializers 457a0 is provided to rank 0 data signal transmitters 4320 which outputs the rank 0 write data on device side data signals MDQa0[ ] synchronized by strobe signals output by rank 0 data strobe signal interfaces 433s0. Rank 1 write data output by rank 1 write data serializers 457a1 is provided to rank 1 data signal transmitters 432t1 which outputs the rank 1 write data on device side data signals MDQa1[ ] synchronized by strobe signals output by rank 1 data strobe signal interfaces 433s1.

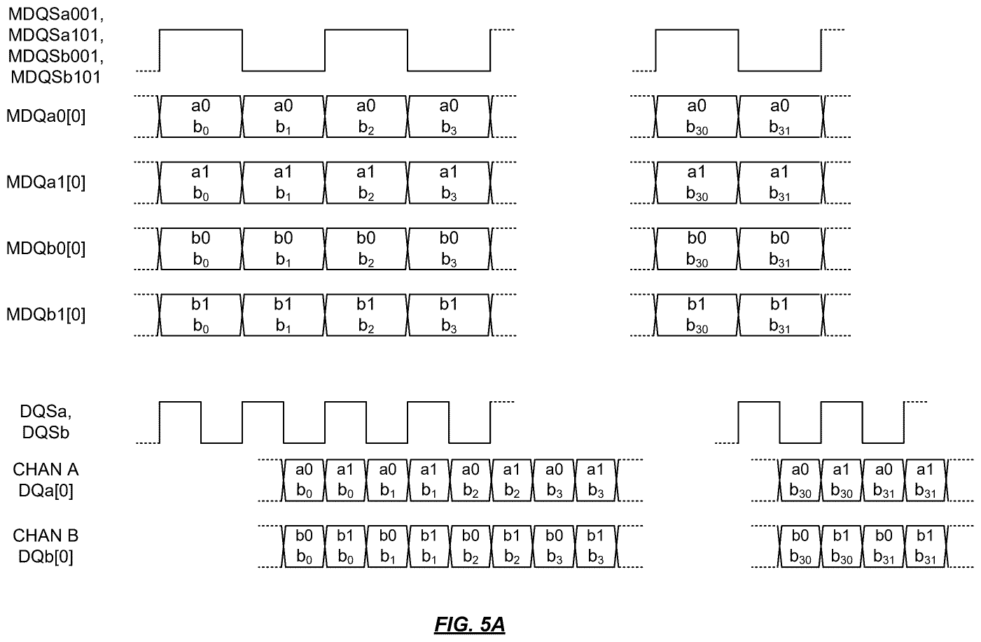

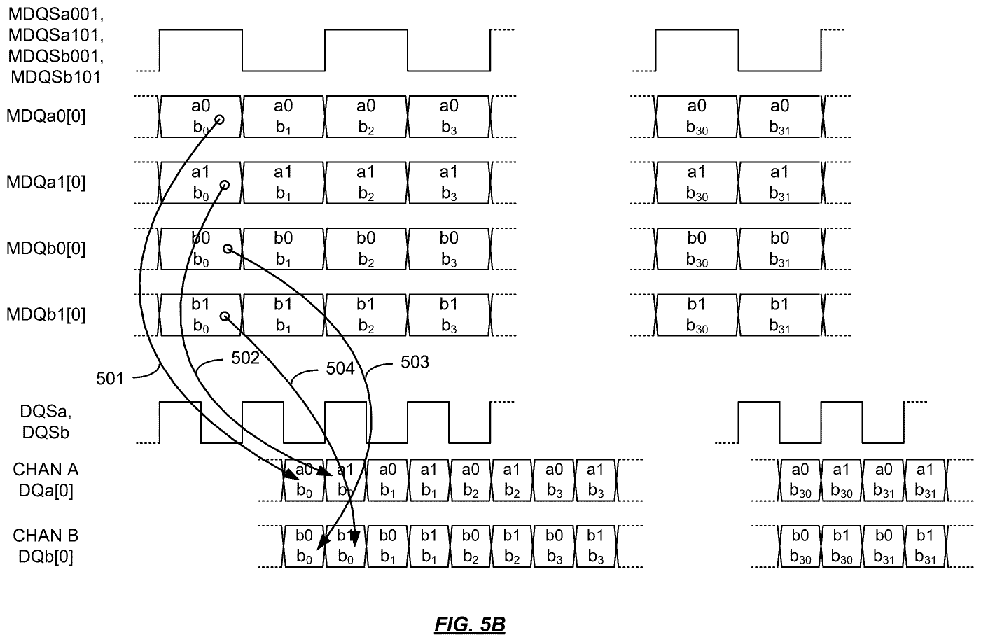

In the following description and FIGS. 5A-5B, 6, and 7, the buffer commands on buffer command buses BCOMa[ ] and BCOMb[ ] are described and illustrated. However, for the sake of brevity, it should be understood that there are corresponding commands on the DRAM device CA interfaces. The DRAM device commands and the buffer commands work together to accomplish the transfer of data to/from the DRAM devices through the buffer.

FIG. 5A-5B are timing diagrams illustrating an example interleaving of data for multiple ranks per channel. In FIGS. 5A-5B, example communication via a data buffer device (e.g., interleaving/deinterleaving 130, MDB 230a-230e, buffer 330, and/or buffer circuitry 400) configured to interleave/deinterleave data signals from/to channels of a dual-channel memory device (e.g., memory device 110a, memory device 110d, memory devices 210a-2101) for communication with a controller (e.g., controller 120) is illustrated.

In FIGS. 5A-5B, data transfers from the memory devices are timed by first timing reference signals (e.g., data strobes) MDQSa001, MDQSa101, MDQSb001, and MDQSb101. Data transfers to the controller/host are timed by second timing reference signals DQSa and DQSb that are running at twice the rate of MDQSa001 and MDQSb001. In FIGS. 5A-5B, signals MDQa0[0] and MDQb0[0] being communicated between the buffer device and respective channels of a rank 0 dual-channel memory device is illustrated. Also in FIGS. 5A-5B, signals MDQa1[0] and MDQb1[0] being communicated between the buffer device and respective channels of a rank 1 dual-channel memory device is illustrated. Also illustrated in FIGS. 5A-5B, channel A data signal DQa[0] and channel B data signals DQb[0] are illustrated respectively being communicated with a first host memory channel (e.g., channel A) and a second host memory channel (e.g., channel B).

In FIGS. 5A-5B, MDQa0[0] carries a burst of data bits (e.g., 32-bit burst) timed by MDQSa001 and shown as bits a0b₀ to a0b₃₁; MDQa1[0] carries a burst of data bits (e.g., 32-bit burst) timed by MDQSa101 and shown as bits a1b₀ to a1b₃₁; MDQb0[0] carries a burst of data bits (e.g., 32-bit burst) timed by MDQSb001 and shown as bits b0b₀ to b0b₃₁; and MDQb1[0] carries a burst of data bits (e.g., 32-bit burst) timed by MDQSb101 and shown as bits b1b₀ to b1b₃₁.

The data buffer device interleaves the bits transferred via MDQa0[0] (from channel A of the rank 0 memory device) with the bits transferred via MDQa1[0] (from channel A of the rank 1 memory device) for communication with the controller via data signal DQa[0] (and timed by DQSa). This is illustrated by example in FIG. 5B by a0b₀ on DQa[0] being followed by a1b₀ on DQa[0] and arrow 501 running from a0b₀ on MDQa0[0] to a0b₀ on DQa[0] and arrow 502 running from a1b₀ on MDQa1[0] to a1b₀ on DQa[0].

Similarly, the data buffer device interleaves the bits transferred via MDQb0[0] (from channel B of the rank 0 memory device) with the bits transferred via MDQb1[0] (from channel B of the rank 1 memory device) for communication with the controller via data signal DQb[0] (and timed by DQSb). This is illustrated by example in FIG. 5B by b0b₀ on DQb[0] being followed by b1b₀ on DQb[0] and arrow 503 running from b0b₀ on MDQb0[0] to b0b₀ on DQb[0] and arrow 504 running from b1b₀ on MDQb1[0] to b1b₀ on DQb[0].

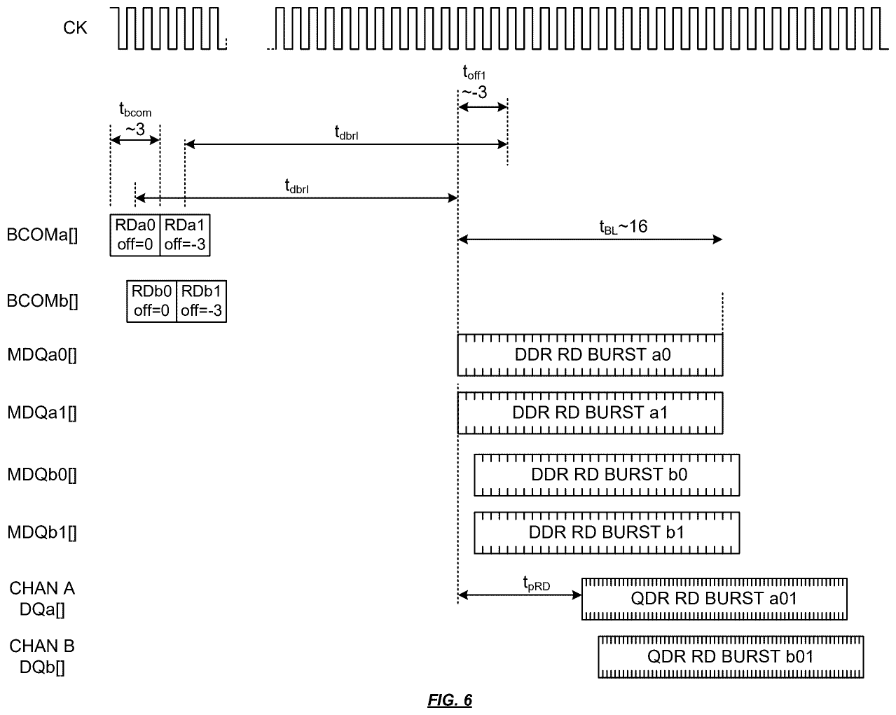

FIG. 6 is a timing diagram illustrating data buffer read operations. The sequence illustrated in FIG. 6 begins with a first read command (RDa0 with a timing offset of zero cycles) to transfer data from channel A of a rank 0 dual-channel memory device being communicated (e.g., to buffers 230a-230e) via a channel A buffer command bus (BCOMa[ ]). The first read command is communicated over a period of t_{bcom} (e.g., ˜3 CK cycles). Immediately succeeding the first read command on the BCOMa[ ] bus, a second read command (RDa1 with a timing offset of minus 3 CK cycles) to transfer data from channel A of a rank 1 dual-channel memory device is communicated via the BCOMa[ ] bus (also over a period of t_{bcom}). After a data buffer read latency period (t_{dbrl}) from when the RDa0 command was communicated, a first read data burst (BURST a0) is received from the channel A interface of the rank 0 memory device via the MDQa0[ ] data bus using a double data rate transfer interval. This data burst occurs over a burst length period of t_{BL} (e.g., ˜16 CK cycles). After the data buffer read latency period (t_{dbrl}) plus the negative timing offset of three cycles (i.e., t_{off}=−3 CK cycle) specified by the RDa1 command from when the RDa1 command was communicated, a second read data burst (BURST a1) is received from the channel A interface of the rank 1 memory device via the MDQa1[ ] data bus using a double data rate transfer interval. This data burst also occurs over a burst length period of t_{BL} (e.g., ˜16 CK cycles). Thus, it should be understood from FIG. 6 that because RDa1 was communicated three cycles later (i.e., 3 cycle delay) than RDa0, and RDa1 specified a minus three cycle timing offset (i.e., t_{off}=−3 CK cycle), the data being communicated for the RDa0 command on MDQa0[ ] and the data being communicated for RDa1 command on MDQa1[ ] start to arrive at the data buffer device during the same clock cycle.

Beginning during the communication of the RDa0 command via the BCOMa[ ] bus, a third read command (RDb0 with a timing offset of zero cycles) to transfer data from channel B of the rank 0 dual-channel memory device is communicated (e.g., to buffers 230a-230b) via a channel B buffer command bus (BCOMb[ ]). The third read command is communicated over a period of t_{bcom} (e.g., ˜3 CK cycles). Immediately succeeding the third read command on the BCOMb[ ] bus, a fourth read command (RDb1 with a timing offset of minus 3 CK cycles) to transfer data from channel B of the rank 1 dual-channel memory device is communicated via the BCOMb[ ] bus (also over a period of t_{bcom}). After a data buffer read latency period (t_{dbrl}) from when the RDb0 command was communicated, a third read data burst (BURST b0) is received from the channel B interface of the rank 0 memory device via the MDQb0[ ] data bus using a double data rate transfer interval. This data burst occurs over a burst length period of t_{BL} (e.g., ˜16 CK cycles). After the data buffer read latency period (t_{dbrl}) plus the negative timing offset of three cycles (i.e., t_{off}=−3 CK cycle) specified by the RDb1 command from when the RDb1 command was communicated, a fourth read data burst (BURST b1) is received from the channel B interface of the rank 1 memory device via the MDQb1[ ] data bus using a double data rate transfer interval. This data burst also occurs over a burst length period of t_{BL} (e.g., ˜16 CK cycles). Thus, it should be understood from FIG. 6 that because RDb1 was communicated three cycles later (i.e., 3 cycle delay) than RDb0, and RDb1 specified a minus three cycle timing offset (i.e., t_{off}=−3 CK cycle), the data being communicated for the RDb0 command on MDQa0[ ] and the data being communicated for RDb1 command on MDQb1[ ] start to arrive at the data buffer device during the same clock cycle.

After a read propagation/processing/interleaving/synchronization delay t_{pRD} from the start of BURST a0 on MDQa0[ ], a quad data rate burst of interleaved data from BURST a0 on MDQa0[ ] and BURST a1 on MDQa1[ ] is communicated (transmitted) via controller side data bus DQa[ ]. This data burst occurs over a burst length period of t_{BL} (e.g., ˜16 CK cycles). Similarly, after a read propagation/processing/interleaving/synchronization delay t_{pRD} from the start of BURST b0 on MDQb0[ ], a quad data rate burst of interleaved data from BURST b0 on MDQb0[ ] and BURST b1 on MDQb1[ ] is communicated (transmitted) via controller side data bus DQb[ ]. This data burst occurs over a burst length period of t_{BL} (e.g., ˜16 CK cycles).

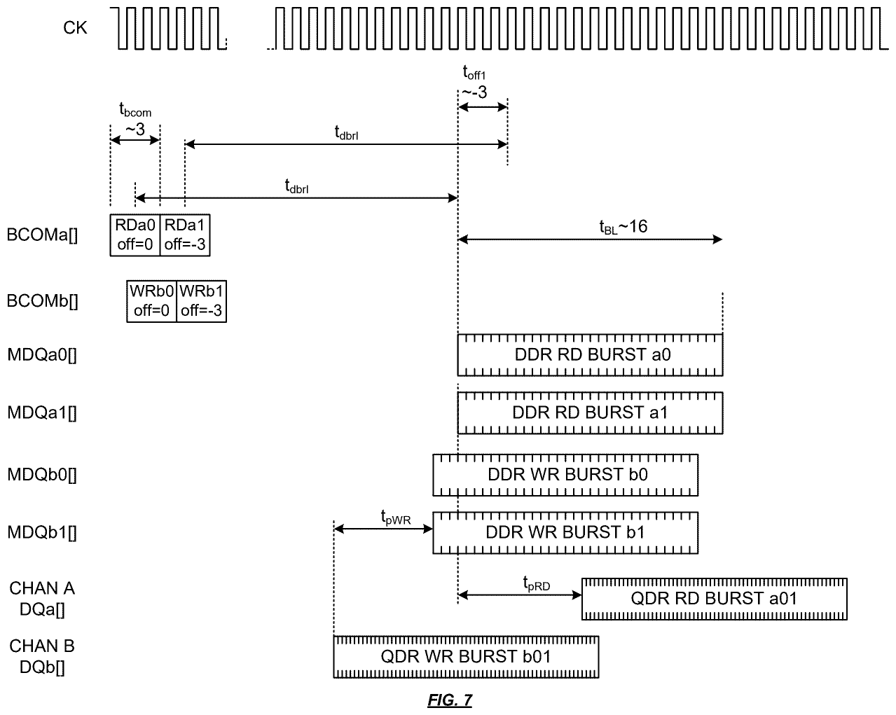

FIG. 7 is a timing diagram illustrating data buffer read operations of a first channel interface of pair of ranks and data buffer write operations to a second channel interface of the pair of ranks. The sequence illustrated in FIG. 7 begins with a first read command (RDa0 with a timing offset of zero cycles) to transfer data from channel A of a rank 0 dual-channel memory device being communicated (e.g., to buffers 230a-230e) via a channel A buffer command bus (BCOMa[ ]). The first read command is communicated over a period of t_{bcom} (e.g., ˜3 CK cycles). Immediately succeeding the first read command on the BCOMa[ ] bus, a second read command (RDa1 with a timing offset of minus 3 CK cycles) to transfer data from channel A of a rank 1 dual-channel memory device is communicated via the BCOMa[ ] bus (also over a period of t_{bcom}). After a data buffer read latency period (t_{dbrl}) from when the RDa0 command was communicated, a first read data burst (BURST a0) is received from the channel A interface of the rank 0 memory device via the MDQa0[ ] data bus using a double data rate transfer interval. This data burst occurs over a burst length period of t_{BL} (e.g., ˜16 CK cycles). After the data buffer read latency period (t_{dbrl}) plus the negative timing offset of three cycles (i.e., t_{off}=−3 CK cycle) specified by the RDa1 command from when the RDa1 command was communicated, a second read data burst (BURST a1) is received from the channel A interface of the rank 1 memory device via the MDQa1[ ] data bus using a double data rate transfer interval. This data burst also occurs over a burst length period of t_{BL} (e.g., ˜16 CK cycles). Thus, it should be understood from FIG. 7 that because RDa1 was communicated three cycles later (i.e., 3 cycle delay) than RDa0, and RDa1 specified a minus three cycle timing offset (i.e., t_{off}=−3 CK cycle), the data being communicated for the RDa0 command on MDQa0[ ] and the data being communicated for RDa1 command on MDQa1[ ] start to arrive at the data buffer device during the same clock cycle.

Beginning during the communication of the RDa0 command via the BCOMa[ ] bus, a first write command (WRb0 with a timing offset of zero cycles) to transfer data to channel B of the rank 0 dual-channel memory device is communicated (e.g., to buffers 230a-230b) via a channel B buffer command bus (BCOMb[ ]). The first write command is communicated over a period of t_{bcom} (e.g., ˜3 CK cycles). Immediately succeeding the first write command on the BCOMb[ ] bus, a second write command (WRb1 with a timing offset of minus 3 CK cycles) to transfer data to channel B of the rank 1 dual-channel memory device is communicated via the BCOMb[ ] bus (also over a period of t_{bcom}). After a data buffer write latency period from when the WRa0 command was communicated, a first write data burst (BURST b0) is transmitted to the channel B interface of the rank 0 memory device via the MDQb0[ ] data bus using a double data rate transfer interval and concurrently with the first write data burst, a second write data burst (BURST b1) is transmitted to the channel B interface of the rank 1 memory device via the MDQb1[ ] data bus using a double data rate transfer interval. These data bursts also occur over a burst length period of t_{BL} (e.g., ˜16 CK cycles). A write propagation/processing/deinterleaving/synchronization delay t_{pWR} prior to the transmission of BURST b0 via MDQb0[ ] and BURST b1 via MDQb1[ ], a quad data rate burst (BURST b01) with the BURST b0 and BURST b1 write data starts to be communicated via DQb[ ] to the data buffer. This data burst occurs over a burst length period of t_{BL} (e.g., ˜16 CK cycles).

FIG. 6 and FIG. 7 (and other Figures—e.g., FIGS. 2A-2B) illustrate a system with two physical buffer command buses (e.g., BCOMa[ ] and BCOMb[ ]) communicating with each MDB. In particular, commands associated with a pseudo channel A (e.g., MDQa0[ ], MDQa1[ ], and DQa[ ]) are illustrated as being communicated using BCOMa[ ] and commands associated with pseudo channel B (e.g., MDQb0[ ], MDQb1[ ], and DQb[ ]) are illustrated as being communicated using BCOMb[ ]. In an embodiment, however, instead of having separate physical command busses for each pseudo channel, buffer commands associated with separate pseudo channels and/or ranks may be combined into merged commands that are carried by a single physical buffer command bus. Such commands may be associated with one or more indicators of which pseudo channel(s) is (are) the target(s) for the associated command(s) (e.g., indicator of a logical pseudo channel BC-A or BC-B, etc. and rank). For example, an example of such a read command may indicate it is directed to pseudo channel A rank0 and pseudo channel B rank1 of the MDB (e.g., RDa0b1—meaning read a0 and read b1 concurrently) and is communicated using a single command communicated via a single physical buffer command bus). In another example of such a read command, the command may indicate it is directed to pseudo channel A rank0 and pseudo channel A rank1 (e.g., RDa0a1—meaning read a0 and read a1 concurrently). This embodiment may result in more or better timing alignment between the pseudo channels. In another embodiment, buffer commands associated with separate pseudo channels and/or ranks may be time-multiplexed and then carried by a single physical buffer command bus.

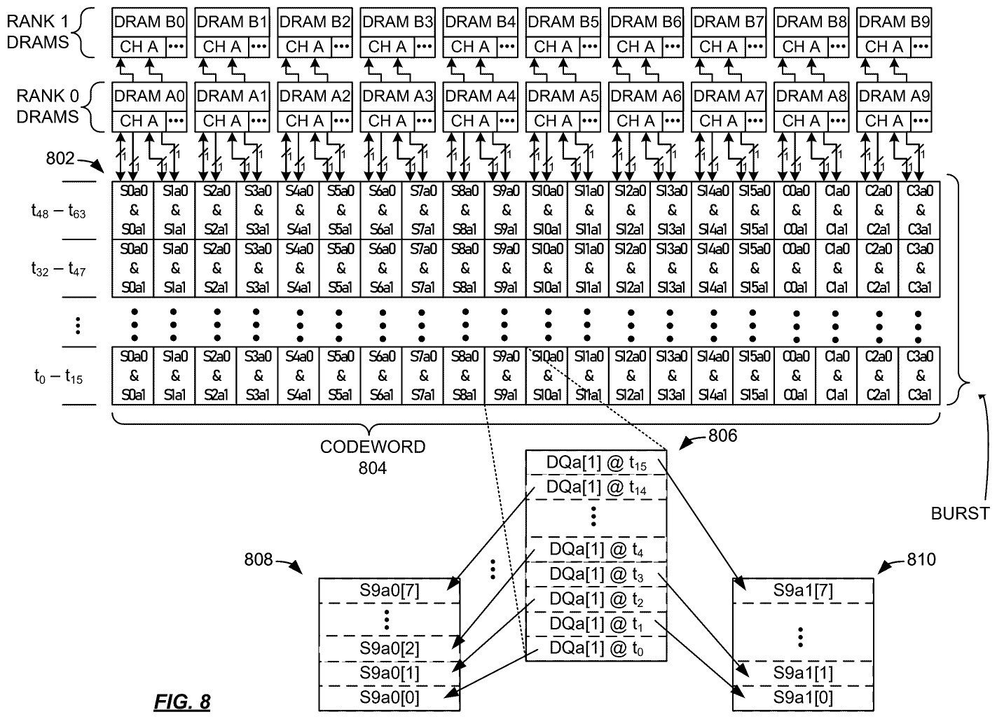

FIG. 8 is a diagram illustrating a codeword configuration. In FIG. 8, a burst 802 from a memory module (e.g., memory module 200a and/or module 200b) includes sixty-four (64) timeslots labeled t₀ through t₆₃. A channel (e.g., channel A) of each rank 0 dual-channel DRAM device (e.g., DRAM devices A0-A9 210a-210c) communicates two (2) bits (i.e., N=2) per burst 802 timeslot via data buffer devices (e.g., data buffer devices BL0-BL4 230a-230b). Each respective codeword 804 of burst 802 is composed of sixteen (16) data symbols S0a0-S15a0 and S0a1-S15a1, and three (3) check symbols C0a0-C2a0 and C0a1-C2a1, and one additional symbol that may be a check symbol C3a0 and C3a1 or used to carry additional data (not shown in FIG. 8). For the purposes of simplicity, this additional symbol will be referred to hereinafter as check symbols C3a0 and C3a1. Each symbol S0a0-S15a0, S0a1-S15a1, Ca0-C3a0, and C0a1-C3a1 of respective codewords 804 is composed of eight (8) bits communicated with a single rank 0 DRAM device A0-A9 over eight (8) burst 802 timeslots that are interleaved with eight (8) bits communicated with a single rank 1 DRAM device B0-B9 over eight (8) other burst 802 timeslots. See, for example, interleaved timeslots t₀-t₁₅ carrying symbol S9a0 and S9a1 called out in detail in FIG. 8. Interleaved symbols 806 is composed of DQa[1] communicated with rank 0 DRAM A4 in timeslot t₀, DQa[1] communicated with rank 1 DRAM B4 in timeslot t₁, DQa[1] communicated with rank 0 DRAM A4 in timeslot t₂, and so on through timeslot t₁₅—thereby forming a first eight bit symbol s9a0 808 communicated using eight even numbered timeslots (t₀, t₂, . . . t₁₄) and a second a second eight bit symbol s9a1 810 communicated using eight odd numbered timeslots (t₁, t₃, . . . t₁₅).

It should be understood that each codeword 804 is composed of 160 bits organized as twenty total 8-bit symbols. The twenty total symbols are composed of sixteen data symbols and either three or four check symbols. Thus, codeword 804 may be generated, checked, and corrected (e.g., by EDC circuitry of controller 120) using either a RS(20,16) or RS(20,17) error detection and correction scheme.

Using results from EDC circuitry, a controller may determine whether errors in codewords 804 are persistent. The RS(20,16) and RS(20,17) schemes provide single symbol data correct and double symbol data detect (SSDC/DSDD) capability. If the controller determines an error is persistent and associated with one channel (e.g., either channel A or channel B) of a memory device, the controller may change the RAS scheme for that channel such that one channel is using a different RAS scheme than the other channel. For example, channel A may have one bad symbol per code words and thereby be using a RS(20,16) scheme, while all of channel B symbols are not exhibiting persistent errors and are therefore use an RS(20,17) scheme.

In an embodiment, four (4) check symbols and sixteen (16) data symbols may be used—i.e., RS(20,16). Using this type of codeword provides “Single Device Data Correction” (SDDC—a.k.a., “chipkill”) protection. SDDC allows the complete failure of one DRAM device to be detected and corrected. In another embodiment, additional data (e.g., metadata associated with the other sixteen data symbols) is stored/transmitted rather than a fourth check symbol. In this case, there are three (3) check symbols and sixteen (16) data symbols that are EDC protected—i.e., RS(20,17). Using this type of codeword provides SSDC/DSDD protection.

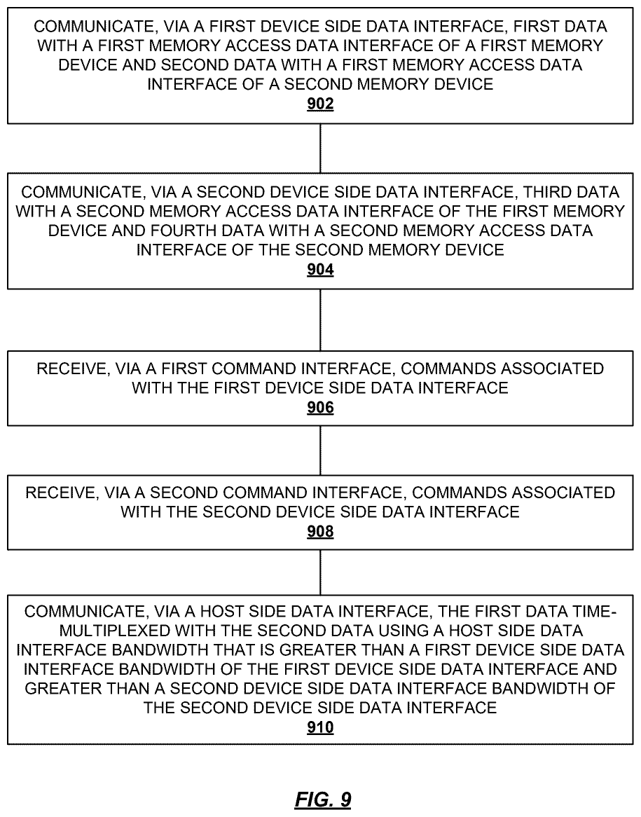

FIG. 9 is a flowchart illustrating a method of operating a data buffer device. One or more of the steps illustrated in FIG. 9 may be performed by, for example, memory system 100, module 200a, module 200b, buffer 330, buffer circuitry 400, and/or their components. Via a first device side data interface, first data is communicated with a first memory access data interface of a first memory device and second data is communicated with a first memory access data interface of a second memory device (902). For example, data buffer device 230a of module 200a and/or module 200b may communicate, via DQ interface 232aa, a first burst of data with channel A interface 211aa of rank 0 DRAM A0 210a and communicate, via DQ interface 232aa, a second burst of data with channel A interface 211da of rank 1 DRAM B0 210d.

Via a second device side data interface, third data is communicated with a second memory access data interface of the first memory device and fourth data is communicated with a second memory access data interface of the second memory device (904). For example, data buffer device 230a of module 200a and/or module 200b may communicate, via DQ interface 232ab, a third burst of data with channel B interface 211ab of rank 0 DRAM A0 210a and communicate, via DQ interface 232ab, a fourth burst of data with channel B interface 211db of rank 1 DRAM B0 210d. Via a first command interface, commands associated with the first device side interface are received (906). For example, via BC-A signals, data buffer device 230a may receive commands associated with data communication for reads and writes via DQ interface 232aa. Via a second command interface, commands associated with the second device side interface are received (908). For example, via BC-B signals, data buffer device 230a may receive commands associated with data communication for reads and writes via DQ interface 232ab.

Via a host side data interface, the first data time-multiplexed with the second data is communicated using a host side data interface bandwidth that is greater than a first device side data interface bandwidth of the first device side data interface and greater than a second device side data interface bandwidth of the second device side data interface (910). For example, data buffer device 230a may communicate, via channel A DQ interface 231aa, the first data burst data time-interleaved with the second data burst data using a data rate that is twice the data rate used for communication via DQ interface 232aa.

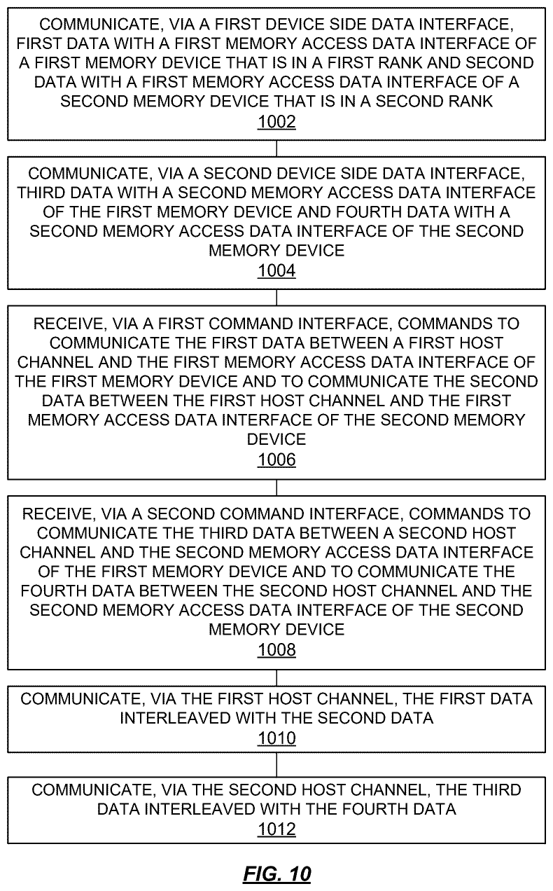

FIG. 10 is a flowchart illustrating a method of communicating data with multiple ranks of memory devices. One or more of the steps illustrated in FIG. 10 may be performed by, for example, memory system 100, module 200a, module 200b buffer 330, buffer circuitry 400, and/or their components. Via a first device side data interface, first data is communicated with a first memory access data interface of a first memory device that is in a first rank and second data is communicated with a first memory access data interface of a second memory device that is in a second rank (1002). For example, data buffer device 230a of module 200a and/or module 200b may communicate, via DQ interface 232aa, a first burst of data with channel A interface 211aa of rank 0 DRAM A0 210a and communicate, via DQ interface 232aa, a second burst of data with channel A interface 211da of rank 1 DRAM B0 210d.

Via a second device side data interface, third data is communicated with a second memory access data interface of the first memory device and fourth data is communicated with a second memory access data interface of the second memory device (1004). For example, data buffer device 230a of module 200a and/or module 200b may communicate, via DQ interface 232ab, a third burst of data with channel B interface 211ab of rank 0 DRAM A0 210a and communicate, via DQ interface 232ab, a fourth burst of data with channel B interface 211db of rank 1 DRAM B0 210d. Via a first command interface, commands to communicate the first data between a first host channel and the first memory access data interface of the first memory device and to communicate the second data between the first host channel and the first memory access data interface of the second memory device are received (1006). For example, data buffer device 230a may receive, via BC-A bus signals, one or more commands to communicate the first data burst data interleaved with the second data burst data via DQ interface 232aa. Via a second command interface, commands to communicate the third data between a second host channel and the second memory access data interface of the first memory device and to communicate the fourth data between the second host channel and the second memory access data interface of the second memory device are received (1008). For example, data buffer device 230a may receive, via BC-B bus signals, one or more commands to communicate the third data burst data interleaved with the third data burst data via DQ interface 232ab.

Via the first host channel, the first data interleaved with the second data is communicated (1010). For example, data buffer device 230a may communicate the first data burst data interleaved with the second data burst data via controller side channel A DQ interface 232aa. Via the second host channel, the third data interleaved with the fourth data is communicated (1012). For example, data buffer device 230a may communicate the third data burst data interleaved with the fourth data burst data via controller side channel B DQ interface 232ab.

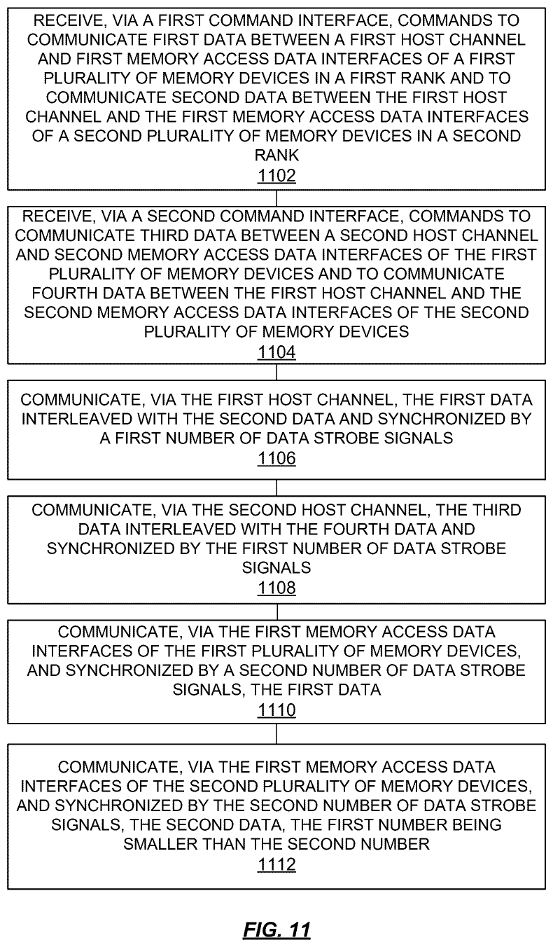

FIG. 11 is a flowchart illustrating a method of communicating data between a channel and multiple ranks of memory devices. One or more of the steps illustrated in FIG. 11 may be performed by, for example, memory system 100, module 200a, module 200b, buffer 330, buffer circuitry 400, and/or their components. Via a first command interface, commands to communicate first data between a first host channel and first memory access data interfaces of a first plurality of memory devices in a first rank and to communicate second data between the first host channel and the first memory access data interfaces of a second plurality of memory devices in a second rank are received (1102). For example, data buffers 230a-230b may receive, via BC-A signals, one or more commands to communicate a first data burst having first data interleaved with second data via channel A interface 245a, to communicate the first data with channel A DQ interfaces 211aa-211ca of rank 0 DRAM devices 210a-210c, and to communicate the second data with channel A DQ interfaces 211da-211fa of rank 1 DRAM devices 210d-210f.

Via a second command interface, commands to communicate third data between a second host channel and second memory access data interfaces of the first plurality of memory devices in the first rank and to communicate fourth data between the second host channel and the second memory access data interfaces of the second plurality of memory devices in the second rank are received (1104). For example, data buffers 230a-230b may receive, via BC-B signals, one or more commands to communicate a second data burst having third data interleaved with fourth data via channel B interface 245b, to communicate the third data with channel B DQ interfaces 211ab-211cb of rank 0 DRAM devices 210a-210c, and to communicate the fourth data with channel B DQ interfaces 211db-211fb of rank 1 DRAM devices 210d-210f.

Via the first host channel, the first data interleaved with the second data is communicated synchronized by a first number of data strobe signals (1106). For example, data buffer devices 230a-230b may communicate, via channel A DQ interfaces 231aa-231ca, the first data burst with channel A interface 245a synchronized by five (5) respective data strobe signals DQS[ ]. Via the second host channel, the third data interleaved with the second data is communicated synchronized by the first number of data strobe signals (1108). For example, data buffer devices 230a-230b may communicate, via channel B DQ interfaces 231ab-231cb, the second data burst with channel B interface 245b synchronized by five (5) respective data strobe signals DQS[ ].

Via the first memory access data interfaces of the first plurality of memory devices, and synchronized by a second number of data strobe signals, the first data is communicated (1110). For example, data buffers 230a-230b may communicate the first data with channel A DQ interfaces 211aa-211ca of rank 0 DRAM devices 210a-210c synchronized by ten (10) respective data strobe signals DQS[ ]. Via the first memory access data interfaces of the second plurality of memory devices, and synchronized by a second number of data strobe signals, the second data is communicated, where the first number is smaller than the second number (1112). For example, data buffers 230a-230b may communicate the second data with channel A DQ interfaces 211da-211fa of rank 1 DRAM devices 210d-210f synchronized by ten (10) respective data strobe signals DQS[ ], where the first data and the second data were communicated with channel A interface 245a using five (5) data strobe signals DQS[ ].

The methods, systems and devices described above may be implemented in computer systems, or stored by computer systems. The methods described above may also be stored on a non-transitory computer readable medium. Devices, circuits, and systems described herein may be implemented using computer-aided design tools available in the art, and embodied by computer-readable files containing software descriptions of such circuits. This includes, but is not limited to one or more elements of memory system 100, module 200a, module 200b, buffer 330, and/or buffer circuitry 400, and their components. These software descriptions may be: behavioral, register transfer, logic component, transistor, and layout geometry-level descriptions. Moreover, the software descriptions may be stored on storage media or communicated by carrier waves.

Data formats in which such descriptions may be implemented include, but are not limited to: formats supporting behavioral languages like C, formats supporting register transfer level (RTL) languages like Verilog and VHDL, formats supporting geometry description languages (such as GDSII, GDSIII, GDSIV, CIF, and MEBES), and other suitable formats and languages. Moreover, data transfers of such files on machine-readable media may be done electronically over the diverse media on the Internet or, for example, via email. Note that physical files may be implemented on machine-readable media such as: 4 mm magnetic tape, 8 mm magnetic tape, 3½ inch floppy media, CDs, DVDs, and so on.

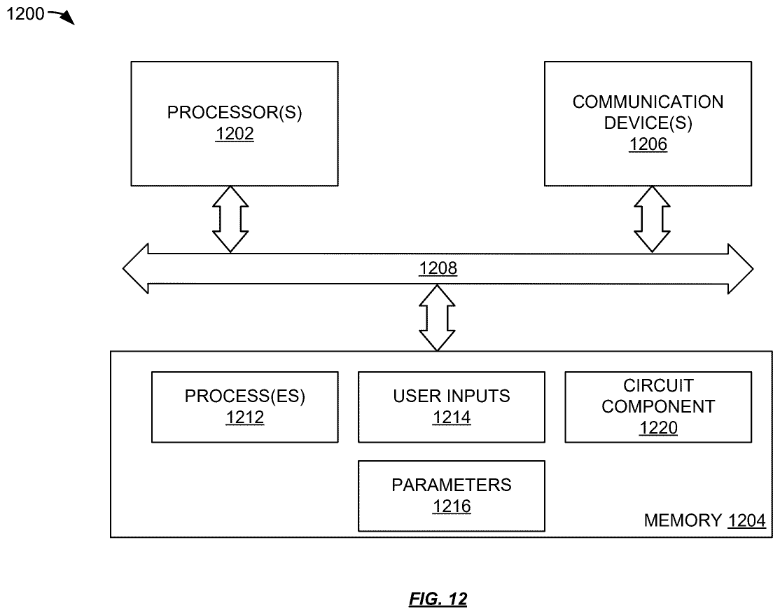

FIG. 12 is a block diagram illustrating one embodiment of a processing system 1200 for including, processing, or generating, a representation of a circuit component 1220. Processing system 1200 includes one or more processors 1202, a memory 1204, and one or more communications devices 1206. Processors 1202, memory 1204, and communications devices 1206 communicate using any suitable type, number, and/or configuration of wired and/or wireless connections 1208.

Processors 1202 execute instructions of one or more processes 1212 stored in a memory 1204 to process and/or generate circuit component 1220 responsive to user inputs 1214 and parameters 1216. Processes 1212 may be any suitable electronic design automation (EDA) tool or portion thereof used to design, simulate, analyze, and/or verify electronic circuitry and/or generate photomasks for electronic circuitry. Representation 1220 includes data that describes all or portions of memory system 100, module 200a, module 200b, buffer 330, and/or buffer circuitry 400, and their components, as shown in the Figures.

Representation 1220 may include one or more of behavioral, register transfer, logic component, transistor, and layout geometry-level descriptions. Moreover, representation 1220 may be stored on storage media or communicated by carrier waves.

Data formats in which representation 1220 may be implemented include, but are not limited to: formats supporting behavioral languages like C, formats supporting register transfer level (RTL) languages like Verilog and VHDL, formats supporting geometry description languages (such as GDSII, GDSIII, GDSIV, CIF, and MEBES), and other suitable formats and languages. Moreover, data transfers of such files on machine-readable media may be done electronically over the diverse media on the Internet or, for example, via email.

User inputs 1214 may comprise input parameters from a keyboard, mouse, voice recognition interface, microphone and speakers, graphical display, touch screen, or other type of user interface device. This user interface may be distributed among multiple interface devices. Parameters 1216 may include specifications and/or characteristics that are input to help define representation 1220. For example, parameters 1216 may include information that defines device types (e.g., NFET, PFET, etc.), topology (e.g., block diagrams, circuit descriptions, schematics, etc.), and/or device descriptions (e.g., device properties, device dimensions, power supply voltages, simulation temperatures, simulation models, etc.).

Memory 1204 includes any suitable type, number, and/or configuration of non-transitory computer-readable storage media that stores processes 1212, user inputs 1214, parameters 1216, and circuit component 1220.

Communications devices 1206 include any suitable type, number, and/or configuration of wired and/or wireless devices that transmit information from processing system 1200 to another processing or storage system (not shown) and/or receive information from another processing or storage system (not shown). For example, communications devices 1206 may transmit circuit component 1220 to another system. Communications devices 1206 may receive processes 1212, user inputs 1214, parameters 1216, and/or circuit component 1220 and cause processes 1212, user inputs 1214, parameters 1216, and/or circuit component 1220 to be stored in memory 1204.

Implementations discussed herein include, but are not limited to, the following examples:

Example 1: A data buffer integrated circuit, comprising: a first device side data interface to communicate first data with a first memory access data interface of a first memory device and second data with a first memory access data interface of a second memory device; a second device side data interface to communicate third data with a second memory access data interface of the first memory device and fourth data with a second memory access data interface of the second memory device; a first command interface to receive commands associated with the first device side data interface; a second command interface to receive commands associated with the second device side data interface; and a host side data interface to communicate the first data time-multiplexed with the second data using a host side data interface bandwidth that is greater than a first device side data interface bandwidth and greater than a second device side data interface bandwidth.

Example 2: The data buffer integrated circuit of example 1, wherein a first data communication direction of the first device side data interface is to be operated independently of a second data communication direction of the second device side data interface.

Example 3: The data buffer integrated circuit of example 1, wherein the first device side data interface and the second device side data interface are to be operated to concurrently have a same data communication direction.

Example 4: The data buffer integrated circuit of example 1, wherein the first device side data interface includes a first number of data strobe signals that are each controllable to have different relative timing skews to others of the first number of data strobe signals.

Example 5: The data buffer integrated circuit of example 4, wherein the host side data interface includes a second number of data strobe signals that is less than the first number.

Example 6: The data buffer integrated circuit of example 1, further comprising: a third device side data interface to communicate fifth data with a first memory access data interface of a third memory device and sixth data with a third memory access data interface of a fourth memory device; and a fourth device side data interface to communicate seventh data with a second memory access data interface of the third memory device and eighth data with a second memory access data interface of the fourth memory device, where the first device side data interface, the second device side data interface, the third device side data interface, and the fourth device side data interface each include a first number of data strobe signals that are each controllable to have different relative timing skews to others of the first number of data strobe signals.

Example 7: The data buffer integrated circuit of example 6, wherein the host side data interface includes a second number of data strobe signals that is less than four times the first number.

Example 8: A data buffer integrated circuit, comprising: a plurality of dual channel memory device side data interfaces to communicate data with respective ones of a plurality of dual channel memory devices, each of the plurality of dual channel memory device side data interfaces including a first data channel interface and a second data channel interface, each of the first data channel interfaces to communicate with respective ones of a first data channel interface of the plurality of dual channel memory devices, each of the second data channel interfaces to communicate with respective ones of a second data channel interface of the plurality of dual channel memory devices; a first data channel command interface to receive commands associated with the first data channel interfaces; a second data channel command interface to receive commands associated with the second data channel interfaces; and a host data channel interface to communicate data transferred via the plurality of dual channel memory device side data interfaces where data transferred via the first data channel interfaces is interleaved with data transferred via the second data channel interfaces.

Example 9: The data buffer integrated circuit of example 8, wherein a first data communication direction of the first data channel interfaces is independent of a second data communication direction of the second data channel interfaces.

Example 10: The data buffer integrated circuit of example 8, wherein the first data channel interfaces and the second data channel interfaces dependent upon being in a same data communication direction.

Example 11: The data buffer integrated circuit of example 8, wherein the first data channel interfaces and the second data channel interfaces each include a first number of data strobe signals that are each controllable to have different relative timing skews to others of the first number of data strobe signals of the first data channel interfaces and the second data channel interfaces.

Example 12: The data buffer integrated circuit of example 11, wherein the host data channel interface includes a second number of data strobe signals that is less than the first number.

Example 13: The data buffer integrated circuit of example 11, wherein the host data channel interface includes a second number of data strobe signals that is less than four times the first number.

Example 14: The data buffer integrated circuit of example 1, further comprising: registering clock driver circuitry.

Example 15: A method of operating an integrated circuit, comprising: communicating, via a first device side data interface, first data with a first memory access data interface of a first memory device and second data with a first memory access data interface of a second memory device; communicating, via a second device side data interface, third data with a second memory access data interface of the first memory device and fourth data with a second memory access data interface of the second memory device; receiving, via a first command interface, commands associated with the first device side data interface; receiving, via a second command interface, commands associated with the second device side data interface; and communicating, via a host side data interface, the first data time-multiplexed with the second data using a host side data interface bandwidth that is greater than a first device side data interface bandwidth of the first device side data interface and greater than a second device side data interface bandwidth of the second device side data interface.

Example 16: The method of example 15, further comprising: operating, with respect to data communication direction, the first device side data interface independently of the second device side data interface.

Example 17: The method of example 15, wherein a data communication direction of the second device side data interface depends on the data communication direction of the first device side data interface.

Example 18: The method of example 15, further comprising: communicating, via the first device side data interface, a first number of data strobe signals having different relative timing skews to others of the first number of data strobe signals.

Example 19: The method of example 18, further comprising: communicating, via the host side data interface, a second number of data strobe signals that is less than the first number.

Example 20: The method of example 15, further comprising: communicating, via a third device side data interface, third data with a first memory access data interface of a third memory device and a third memory access data interface of a fourth memory device; communicating, via a fourth device side data interface, fourth data with a second memory access data interface of the third memory device and a second memory access data interface of the fourth memory device; and communicating, via the first device side data interface, the second device side data interface, the third device side data interface, and the fourth device side data interface, a first number of data strobe signals that have a plurality of relative timing skews to others of the first number of data strobe signals.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A data buffer integrated circuit, comprising:
a first device side data interface to communicate first data with a first memory access data interface of a first memory device and second data with a first memory access data interface of a second memory device;
a second device side data interface to communicate third data with a second memory access data interface of the first memory device and fourth data with a second memory access data interface of the second memory device;
a first command interface to receive commands associated with the first device side data interface;
a second command interface to receive commands associated with the second device side data interface; and
a host side data interface to communicate the first data time-multiplexed with the second data using a host side data interface bandwidth that is greater than a first device side data interface bandwidth and greater than a second device side data interface bandwidth.

2. The data buffer integrated circuit of claim 1, wherein a first data communication direction of the first device side data interface is to be operated independently of a second data communication direction of the second device side data interface.

3. The data buffer integrated circuit of claim 1, wherein the first device side data interface and the second device side data interface are to be operated to concurrently have a same data communication direction.

4. The data buffer integrated circuit of claim 1, wherein the first device side data interface includes a first number of data strobe signals that are each controllable to have different relative timing skews to others of the first number of data strobe signals.

5. The data buffer integrated circuit of claim 4, wherein the host side data interface includes a second number of data strobe signals that is less than the first number.

6. The data buffer integrated circuit of claim 1, further comprising:
a third device side data interface to communicate fifth data with a first memory access data interface of a third memory device and sixth data with a third memory access data interface of a fourth memory device; and
a fourth device side data interface to communicate seventh data with a second memory access data interface of the third memory device and eighth data with a second memory access data interface of the fourth memory device, where the first device side data interface, the second device side data interface, the third device side data interface, and the fourth device side data interface each include a first number of data strobe signals that are each controllable to have different relative timing skews to others of the first number of data strobe signals.

7. The data buffer integrated circuit of claim 6, wherein the host side data interface includes a second number of data strobe signals that is less than four times the first number.

8. A data buffer integrated circuit, comprising:
a plurality of dual channel memory device side data interfaces to communicate data with respective ones of a plurality of dual channel memory devices, each of the plurality of dual channel memory device side data interfaces including a first data channel interface and a second data channel interface, each of the first data channel interfaces to communicate with respective ones of a first data channel interface of the plurality of dual channel memory devices, each of the second data channel interfaces to communicate with respective ones of a second data channel interface of the plurality of dual channel memory devices;
a first data channel command interface to receive commands associated with the first data channel interfaces;
a second data channel command interface to receive commands associated with the second data channel interfaces; and
a host data channel interface to communicate data transferred via the plurality of dual channel memory device side data interfaces where data transferred via the first data channel interfaces is interleaved with data transferred via the second data channel interfaces.

9. The data buffer integrated circuit of claim 8, wherein a first data communication direction of the first data channel interfaces is independent of a second data communication direction of the second data channel interfaces.

10. The data buffer integrated circuit of claim 8, wherein the first data channel interfaces and the second data channel interfaces dependent upon being in a same data communication direction.

11. The data buffer integrated circuit of claim 8, wherein the first data channel interfaces and the second data channel interfaces each include a first number of data strobe signals that are each controllable to have different relative timing skews to others of the first number of data strobe signals of the first data channel interfaces and the second data channel interfaces.

12. The data buffer integrated circuit of claim 11, wherein the host data channel interface includes a second number of data strobe signals that is less than the first number.

13. The data buffer integrated circuit of claim 11, wherein the host data channel interface includes a second number of data strobe signals that is less than four times the first number.

14. The data buffer integrated circuit of claim 1, further comprising:
registering clock driver circuitry.

15. A method of operating an integrated circuit, comprising:
communicating, via a first device side data interface, first data with a first memory access data interface of a first memory device and second data with a first memory access data interface of a second memory device;
communicating, via a second device side data interface, third data with a second memory access data interface of the first memory device and fourth data with a second memory access data interface of the second memory device;
receiving, via a first command interface, commands associated with the first device side data interface;
receiving, via a second command interface, commands associated with the second device side data interface; and
communicating, via a host side data interface, the first data time-multiplexed with the second data using a host side data interface bandwidth that is greater than a first device side data interface bandwidth of the first device side data interface and greater than a second device side data interface bandwidth of the second device side data interface.

16. The method of claim 15, further comprising:
operating, with respect to data communication direction, the first device side data interface independently of the second device side data interface.

17. The method of claim 15, wherein a data communication direction of the second device side data interface depends on the data communication direction of the first device side data interface.

18. The method of claim 15, further comprising:
communicating, via the first device side data interface, a first number of data strobe signals having different relative timing skews to others of the first number of data strobe signals.

19. The method of claim 18, further comprising:
communicating, via the host side data interface, a second number of data strobe signals that is less than the first number.

20. The method of claim 15, further comprising:
communicating, via a third device side data interface, third data with a first memory access data interface of a third memory device and a third memory access data interface of a fourth memory device;
communicating, via a fourth device side data interface, fourth data with a second memory access data interface of the third memory device and a second memory access data interface of the fourth memory device; and
communicating, via the first device side data interface, the second device side data interface, the third device side data interface, and the fourth device side data interface, a first number of data strobe signals that have a plurality of relative timing skews to others of the first number of data strobe signals.
